(19) United States
(12) Patent Application Publication
(10) Pub. No.: US 2026/0033934 A1
(43) Pub. Date: Feb. 5, 2026

(54) ORAL CLEANING DEVICE

(71) Applicant: SHENZHEN LANHE TECHNOLOGIES CO., LTD., Shenzhen City (CN)

(72) Inventors: QUAN LV, Shenzhen City (CN); FASHUO GUAN, Shenzhen City (CN); ZHUOLUO REN, Shenzhen City (CN); GUANG YANG, Shenzhen City (CN); JIAMING CAI, Shenzhen City (CN); YONGJIE XU, Shenzhen City (CN)

(73) Assignee: SHENZHEN LANHE TECHNOLOGIES CO., LTD., Shenzhen City (CN)

(21) Appl. No.: 19/351,302

(22) Filed: Oct. 7, 2025

Related U.S. Application Data
(63) Continuation-in-part of application No. PCT/CN2024/086484, filed on Apr. 7, 2024.

(30) Foreign Application Priority Data
Apr. 10, 2023 (CN) 202320862334.4
Jun. 1, 2023 (CN) 202321389581.3
Aug. 24, 2023 (CN) 202322290676.6
Aug. 24, 2023 (CN) 202322298917.1
Aug. 24, 2023 (CN) 202322313814.8
Nov. 7, 2023 (CN) 202323011766.3
Dec. 13, 2023 (CN) 202323401426.1
Dec. 26, 2023 (CN) 202323574229.X
Dec. 28, 2023 (CN) 202323637344.7
Jan. 4, 2024 (CN) 202410011272.5
May 12, 2025 (CN) 202520918386.8
Sep. 22, 2025 (CN) 202522040052.8

(51) Int. Cl. A61C 17/34; A61C 17/22

(52) U.S. Cl. CPC A61C 17/3481; A61C 17/222

(57) ABSTRACT

A brush head includes a shell and bristles mounted on a side of the shell. The shell includes a first airflow channel and a liquid guiding channel. The first airflow channel includes an air outlet hole facing the side of the shell on which the bristles are arranged and the liquid guiding channel includes a liquid outlet port located at the side of the shell on which the bristles are arranged such that the air output from the first airflow channel and the liquid output from the liquid guiding channel can be mixed at the area around the liquid outlet port to form abundant bubbles.

### CROSS REFERENCE TO RELATED APPLICATIONS

This application is a continuation-in-part of International Patent Application No. PCT/CN2024/086484, filed on Apr. 7, 2024, which claims priority of China Patent Application No. 202320862334.4 filed on Apr. 10, 2023, China Patent Application No. 202321389581.3 filed on Jun. 1, 2023, China Patent Application No. 202322313814.8 filed on Aug. 24, 2023, China Patent Application No. 202322290676.6 filed on Aug. 24, 2023, China Patent Application No. 202322298917.1 filed on Aug. 24, 2023, China Patent Application No. 202323011766.3 filed on Nov. 7, 2023, China Patent Application No. 202323401426.1 filed on Dec. 13, 2023, China Patent Application No. 202323574229.X filed on Dec. 26, 2023, China Patent Application No. 202323637344.7 filed on Dec. 28, 2023 and China Patent Application No. 202410011272.5 filed on Jan. 4, 2024. This application also claims priority of China Patent Application No. CN202520918386.8 filed on May 12, 2025 and China Patent Application No. 202522040052.8 filed on Sep. 22, 2025. The contents of the above-identified applications are incorporated herein by reference.

### TECHNICAL FIELD

The application relates to the technical field of personal care, in particular to an oral cleaning device.

### BACKGROUND

Nowadays, with the improvement of the living standard, people pay more attention to oral hygiene, and oral cleaning devices are popularized accordingly and well received by customers. Oral cleaning devices in the prior art are typically provided with a motor and a brush head, and the motor drives the brush head to swing or rotate to generate friction force to clean teeth so as to fulfil the purpose of tooth brushing. However, existing oral cleaning devices still have defects in product structure and user experience and need to be further improved and developed.

### SUMMARY

It is desired to provide an improved brush head and an oral cleaning device.

In one aspect, the present invention provides a brush head which comprises a shell comprising a first airflow channel and a liquid guiding channel; and bristles arranged at a side of the shell. The first airflow channel comprises an air outlet hole facing the side of the shell on which the bristles are arranged. The liquid guiding channel comprises a liquid outlet port located at the side of the shell on which the bristles are arranged.

In some embodiments, the shell comprises a body portion and a head portion connected to an end of the body portion; the bristles and the air outlet hole of the first airflow channel are arranged at the head portion; and the liquid guiding channel extends through the head portion, the liquid outlet port of the liquid guiding channel is located at a side of the head portion on which the bristles are arranged, and the liquid guiding channel further comprises a liquid inlet port defined at another side of the head portion opposite to or adjacent to the side of the head portion on which the bristles are arranged.

In some embodiments, the head portion has a thickness which gradually decreases from an end, close to the body portion, of the head portion to another end, away from the body portion, of the head portion.

In some embodiments, the shell comprises a protrusion located in the liquid guiding channel; and the air outlet hole of the first airflow channel is defined in the protrusion and faces the liquid outlet port of the liquid guiding channel.

In some embodiments, the shell comprises a head portion. The bristles and the air outlet hole of the first airflow channel are arranged at the head portion. The liquid guiding channel extends through the head portion. The liquid outlet port of the liquid guiding channel is located at a side of the head portion from which the bristles extend in an extending direction. The air outlet hole of the first airflow channel and the liquid outlet port of the liquid guiding channel are spaced apart in a thickness direction of the head portion which is parallel to the extending direction of the bristles.

In some embodiments, the head portion comprises a first part and a second part; the bristles and the liquid inlet port of the liquid guiding channel are arranged at the first part; the liquid outlet port of the liquid guiding channel is defined in the second part; and the first part surrounds the second part with a passage formed therebetween, the passage being in fluid communication with the liquid guiding channel.

In some embodiments, the passage is arranged around the liquid outlet port of the liquid guiding channel. The passage comprises an inlet opening which is located at the side of the head portion on which the liquid outlet port of the liquid guiding channel is arranged.

In some embodiments, the liquid outlet port of the liquid guiding channel is arranged at a side of the second part away from the air outlet hole of the first airflow channel; and the second part comprises a recessed cavity formed at another side thereof adjacent to the air outlet hole of the first airflow channel, the recessed cavity is in communication with the liquid outlet port of the liquid guiding channel, and the recessed cavity faces the air outlet hole of the first airflow channel.

The recessed cavity is flared in a direction toward the air outlet hole of the first airflow channel.

In some embodiments, the shell comprises a body portion and a head portion connected to an end of the body portion; the bristles and the air outlet hole of the first airflow channel are arranged at the head portion; the first airflow channel extends in a lengthwise direction of the body portion; and the first airflow channel comprises an air inlet hole located an end of the body portion away from the head portion.

In some embodiments, the air outlet hole of the first airflow channel has a cross-sectional area less than that of the air inlet hole of the first airflow channel.

In some embodiments, the air outlet hole of the first airflow channel has a cross-sectional area less than that of the liquid outlet port of the liquid guiding channel.

In some embodiments, the bristles are arranged around the air outlet hole of the first airflow channel and the liquid outlet port of the liquid guiding channel.

In some embodiments, the shell comprises a main body part and a flexible part sleeved on the main body part, and the liquid guiding channel extends through the main body part and the flexible part.

In another aspect, the present invention provides an electric toothbrush comprising a housing, an air pump and a brush head described above. The air pump is arranged in the housing, the brush head is connected to an end of the housing, and the air pump comprises an air outlet hole in communication with the air inlet hole of the first airflow channel.

In some embodiments, the electric toothbrush further comprises a vibration motor which comprises a driving shaft connected to the shell, wherein the driving shaft defines a second airflow channel, and opposite two ends of the second airflow channel are connected to the air outlet hole of the air pump and the air inlet hole of the first airflow channel respectively.

In some embodiments, a sealing member is sleeved around the driving shaft to seal the air inlet hole of the first airflow channel.

In some embodiments, the bristles are arranged at an end of the shell away from the housing; a locking member is arranged at another end of the shell adjacent to the housing, the locking member defines a mounting hole in communication with the first airflow channel, and the driving shaft of the vibration motor is mounted in the mounting hole; a limiting portion is provided at said another end of the shell adjacent to the housing for limiting stroke of the driving shaft entering into the mounting hole; and the sealing member is sandwiched between the limiting portion and the locking member.

In some embodiments, a waterproof air inlet cap assembly is provided at an end of the housing away from the brush head; the waterproof air inlet cap assembly comprises an air inlet cap defining through holes, a cover, and a waterproof and air-permeable member; the waterproof and air-permeable member is sandwiched between the air inlet cap and the cover; and a periphery of the waterproof air inlet cap assembly is sealingly connected to the housing.

In some embodiments, the cover comprises a flange protruding from a periphery thereof and configured for pressing the waterproof and air-permeable member against the air inlet cap, an inlet chamber is formed in the cover and surrounded by the flange, an air inlet port is formed in the cover and configured to communicate with the inlet chamber and an air entrance of the air pump.

In some embodiments, the cover comprises multiple ribs extending into the inlet chamber.

The technical solution of the application has at least the following beneficial effects: the airflow hole and the first airflow channel communicated with the airflow hole are formed in the brush head of the oral cleaning device, the airflow generating device and the second airflow channel are arranged in the handle, and an airflow is generated by the airflow generating device and passes through the second airflow channel and the first airflow channel to be sprayed out via the airflow hole, such that the oral cleaning device may spray out abundant microbubbles, clean interdental spaces by means of impact generated by instantaneous collapse and burst of the microbubbles, improve the tooth cleaning effect, and further improve the user experience.

### BRIEF DESCRIPTION OF THE DRAWINGS

To better clarify the technical solutions in the embodiments of the application, drawings used for describing the embodiments of the application or the prior art are briefly introduced below. Apparently, the drawings in the following description merely illustrate some embodiments of the application. For those ordinarily skilled in the art, other drawings may be obtained according to the following ones without creative labor.

FIG. 1 is a schematic structural diagram of an oral cleaning device according to a first embodiment of the application.

FIG. 2 is an exploded structural view of the oral cleaning device in FIG. 1.

FIG. 3 is a sectional structural view of the oral cleaning device in FIG. 1.

FIG. 4 is a partial enlarged view of portion a in FIG. 3.

FIG. 5 is a partial enlarged view of portion b in FIG. 3.

FIG. 6 is a schematic diagram of another brush head of the oral cleaning device in FIG. 1.

FIG. 7 is a partial structural view of the brush head in FIG. 6.

FIG. 8 is a schematic diagram of the brush head in FIG. 6, from another perspective.

FIG. 9 is a schematic diagram of yet another brush head of the oral cleaning device in

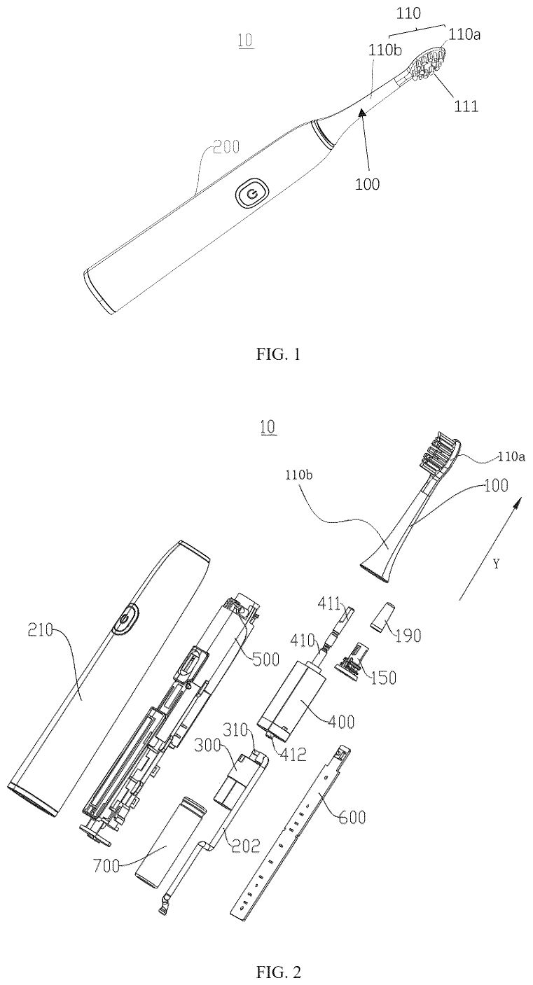

FIG. 1.

FIG. 10 is a schematic diagram of yet another brush head of the oral cleaning device in FIG. 1.

FIG. 11 is a sectional view of the brush head in FIG. 10.

FIG. 12A is a schematic structural diagram of an oral cleaning device according to a second embodiment of the application.

FIG. 12B is a schematic structural diagram of a brush head in FIG. 12A.

FIG. 13 is a sectional structural view of the oral cleaning device in FIG. 12A.

FIG. 14 is a partial enlarged view of region c in FIG. 13.

FIG. 15 is an exploded structural view of the oral cleaning device in FIG. 12A.

FIG. 16 is a schematic structural diagram of a base in FIG. 12B.

FIG. 17A and FIG. 17B are schematic structural diagrams of a sealing member in FIG. 15.

FIG. 18A and FIG. 18B are schematic structural diagrams of a brush head in FIG. 15.

FIG. 19 is a schematic structural diagram of a driving shaft locking member in FIG. 15.

FIG. 20 is an exploded structural view of the brush head in FIG. 15.

FIG. 21 is a schematic structural diagram of a retainer ring in FIG. 15.

FIG. 22 is an exploded structural view of a waterproof air inlet cap assembly in FIG. 12A.

FIG. 23 is a schematic structural diagram of a cover piece in FIG. 22.

FIG. 24 is a schematic structural diagram of an oral cleaning device according to a third embodiment of the application.

FIG. 25 is an overall structural diagram of the oral cleaning device in FIG. 24, from a first perspective, in absence of a housing or in a case where the housing is removed.

FIG. 26 is a partial structural diagram of the oral cleaning device in FIG. 24, from a second perspective, in absence of a housing or in a case where the housing is removed.

FIG. 27 is a schematic structural diagram of cooperative connection between an air inlet tube and an airflow generating assembly of the oral cleaning device in FIG. 24.

FIG. 28 is an exploded view of part of the structure of the oral cleaning device in FIG. 24.

FIG. 29 is a schematic structural diagram of an oral cleaning device according to a fourth embodiment of the application.

FIG. 30 is an exploded structural view of the oral cleaning device in FIG. 29.

FIG. 31 is a sectional structural view of a suspension device in FIG. 30.

FIG. 32 is an exploded structural view of the suspension device in FIG. 30.

FIG. 33 is an exploded structural view of a cleaning device body in FIG. 30.

FIG. 34 is a sectional structural view of the cleaning device body in FIG. 30.

FIG. 35 is a partial enlarged view of region d in FIG. 34.

FIG. 36 is a schematic structural diagram of a suspension device according to a fifth embodiment of the application.

FIG. 37 is a schematic structural diagram of a suspension mounting member in FIG. 36.

FIG. 38A and FIG. 38B are other schematic structural diagrams of the suspension mounting member in FIG. 36.

FIG. 39 is a schematic structural diagram of a suspension fixing member in FIG. 36.

FIG. 40 is a schematic structural diagram of the suspension fixing member in FIG. 36, from another perspective.

FIG. 41 is a sectional structural view of the suspension fixing member.

FIG. 42 is a schematic structural diagram of a suspension device according to a sixth embodiment of the application.

FIG. 43 is an exploded structural view of the suspension device in FIG. 42.

FIG. 44 is a sectional structural view of the suspension device in FIG. 42.

FIG. 45 is an exploded structural view of an oral cleaning device according to the sixth embodiment of the application.

FIG. 46 is a schematic structural diagram of an oral cleaning device according to a seventh embodiment of the application.

FIG. 47 is an exploded structural view of the oral cleaning device in FIG. 46.

FIG. 48 is a sectional structural view of the oral cleaning device in FIG. 46.

FIG. 49 is a partial enlarged view of region e in FIG. 48.

FIG. 50 is a schematic structural diagram of an oral cleaning device according to an eighth embodiment of the application.

FIG. 51 is an exploded structural view of the oral cleaning device in FIG. 50.

FIG. 52 is another exploded structural view of the oral cleaning device in FIG. 50.

FIG. 53 is a schematic working flow diagram of the oral cleaning device in FIG. 50.

FIG. 54 is another schematic working flow diagram of the oral cleaning device in FIG. 50.

FIG. 55 is yet another working flow diagram of the oral cleaning device in FIG. 50.

FIG. 56 is a schematic structural diagram of a brush head according to a ninth embodiment of the present application.

FIG. 57 is a partly enlarged view of portion f of FIG. 56.

FIG. 58 is a cross-sectional view of the brush head shown in FIG. 56.

FIG. 59 is a partly enlarged view of portion g of FIG. 56.

FIG. 60 is a partly enlarged view of portion h of FIG. 56.

FIG. 61 illustrates a part of a brush head according to a tenth embodiment of the present application.

FIG. 62 is a cross-sectional view of FIG. 61.

FIG. 63 illustrates a part of a brush head according to an eleventh embodiment of the present application.

FIG. 64 is a cross-sectional view of FIG. 63.

FIG. 65 is similar to FIG. 56, but viewed from another aspect.

FIG. 66 illustrates an oral cleaning device according to an embodiment of the present application.

FIG. 67 is a cross-sectional view of FIG. 66.

FIG. 68 is a partly enlarged view of portion i of FIG. 57.

FIG. 69 is a partly exposed view of a brush head according to another embodiment of the present application.

FIG. 70 illustrates a second part of a head portion of the brush head shown in FIG. 69.

FIG. 71 is an assembled view of FIG. 69.

### DESCRIPTION OF THE EMBODIMENTS

The technical solutions in the embodiments of the present application are clearly and completely described below in conjunction with accompanying drawings of the embodiments of the application. Apparently, the embodiments described below are merely illustrative ones and are not all possible ones of the application. All other embodiments obtained by those ordinarily skilled in the art based on the following ones without creative labor should also fall within the protection scope of the application.

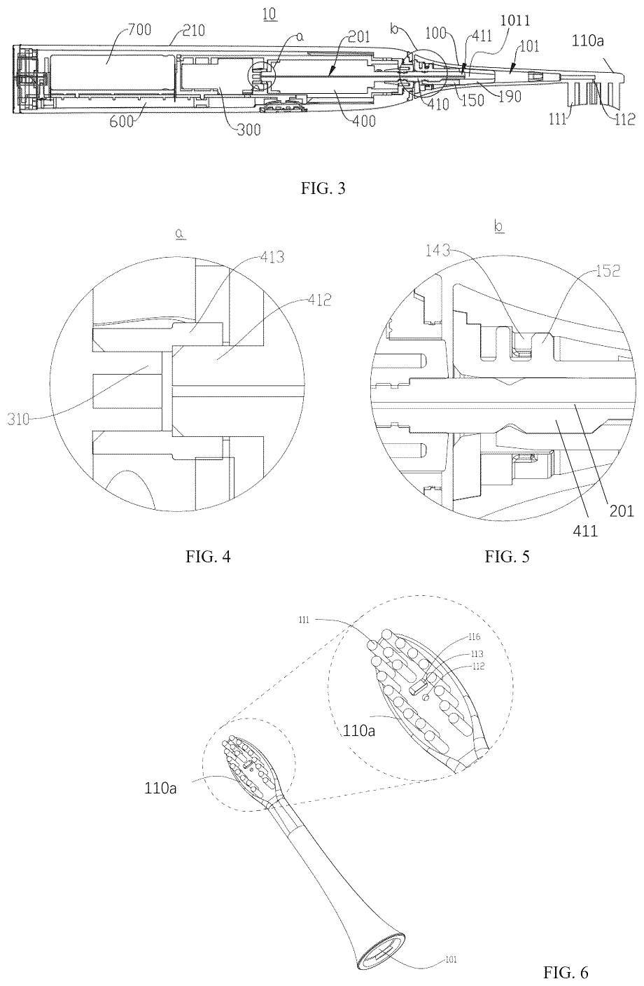

Referring to FIGS. 1, 2 and 3, an oral cleaning device 10 in accordance with a first embodiment of the present application specifically may include, for example, a brush head 100, a handle 200 and an airflow generating device 300. The oral cleaning device 10 may be an electric toothbrush.

The brush head 100 comprises a shell 110 and bristles 111 mounted on the shell 110. The shell 110 comprises a base 110a, which may be named as head portion 110a, and a body portion 110b extending from the base 110a in a length direction Y of the brush head 100. One side of the base 110a is provided with the bristles 111 and an airflow hole 112. The airflow hole 112 and the bristles 111 may be arranged, for example, on the same side of the base 110a. One or more airflow holes 112, for example, may be arranged, and the embodiment has no limitation in this aspect. A first airflow channel 101 is formed in the shell 110 of the brush head 100, and the first airflow channel 101 is in communication with the airflow hole 112. The airflow hole 112 acts as the air outlet hole 112 of the first airflow channel 101. The first airflow channel 101 comprises an air inlet hole 1011 located at an end of the body portion 110b of the shell 110 away from the bristles 111. Optionally, the air outlet hole 112 of the first airflow channel 101 has a cross-sectional area less than that of the air inlet hole 1011 of the first airflow channel 101. The cross-sectional area of the air outlet hole 112 means the area of the cross section, which is perpendicular to the airflow direction of air passing through the air outlet hole 112, of the air outlet hole 112. The cross-sectional area of the air inlet hole 1011 means the area of the cross section, which is perpendicular to the airflow direction of air passing through the air inlet hole 1011, of the air inlet hole 1011. The first airflow channel 101 may be formed, for example, by hollowing out the shell 110 of the brush head 100 or may be formed, for example, by arranging an airflow tube in the shell 110 of the brush head 100, and the formation of the first airflow channel 101 described here is merely illustrative. The handle 200 may include, for example, a housing 210 and the handle 200 is connected to the brush head 100. The handle 200 may be, for example, detachably connected to the brush head 100 or may be, for example, fixedly connected to the brush head 100. A second airflow channel 201 is formed in the housing 210, and the second airflow channel 201 is in communication with the first airflow channel 101. In a case where the brush head 100 is fixedly connected to the handle 200, the first airflow channel 101 and the second airflow channel 201 may be, for example, fixedly connected to each other or may be, for example, one airflow channel that is formed integrally. In a case where the brush head 100 is detachably connected to the handle 200, the first airflow channel 101 and the second airflow channel 201 may be, for example, detachably connected to each other.

The airflow generating device 300 is arranged in the housing 210. The airflow generating device 300 comprises an airflow output port 310, and the airflow output port 310 is connected to the second airflow channel 201. The airflow generating device 300 may be, for example, an air pump, and to be specific, the airflow generating device 300 is a diaphragm pump, an electromagnetic pump, or the like. The airflow generating device 300 may include, for example, an air intake port, and the housing 210 is provided with, for example, one or more air inlets. The air inlet may be formed, for example, in the housing 210 close to the airflow generating device 300 or may be formed, for example, in other positions of the housing 210 as needed. In this way, air may enter the airflow generating device 300 through the air inlet and the air intake port to enable the airflow generating device 300 to generate an airflow. Alternatively, an air inlet tube 202 is arranged in the housing 210, one end of the air inlet tube 202 is connected to the air intake port of the airflow generating device 300, and the other end of the air inlet tube 202 is exposed to outside of the housing 210, such that air may enter the airflow generating device 300 through the air inlet tube 202. A check valve, for example, may be arranged in the air inlet tube 202 to ensure that air flows in unidirectionally to improve the airflow generating effect. The airflow generating device 300 may generate an airflow, and the airflow passes through the second airflow channel 201 and the first airflow channel 101 to be sprayed out via the airflow hole 112. In this way, the oral cleaning device 10 may spray out the airflow via the airflow hole 112, the airflow sprayed out via the airflow hole 112 generates dense microbubbles together with toothpaste and water, and interdental spaces are cleaned by means of impact generated by instantaneous collapse and burst of the microbubbles, which enhances the tooth cleaning effect and further improves the user experience.

The oral cleaning device 10 may further include, for example, a vibrating element for driving the bristles 111 of the brush head 100 to swing or rotate. The vibrating element may be, for example but not limited to, a motor 400. The motor 400 is arranged in the housing 210. To be specific, the motor 400 may be arranged, for example, on a side, close to the brush head 100, of the airflow generating device 300. The motor 400 is connected to the brush head 100 and may drive the bristles 111 to swing or rotate by means of the brush head 100, to generate friction force to clean teeth. A support 500, a circuit board 600 and a battery 700, for example, may be further arranged in the housing 210. The support 500 is arranged in the housing 210. The airflow generating device 300, the motor 400, the circuit board 600 and the battery 700 are arranged on the support 500. The battery 700 is electrically connected to the airflow generating device 300, the motor 400 and the circuit board 600 and configured to supply power to the motor 400, the airflow generating device 300 and the circuit board 600. The oral cleaning device 10 may be further provided with, for example, switches. The switches are electrically connected to the circuit board 600. The circuit board 600 is configured to turn on or off the corresponding switches to control operation of the motor 400 and the airflow generating device 300. The airflow generating device 300 is arranged between the motor 400 and the battery 700 in a longitudinal direction of the housing 210. The motor 400 is arranged at an end of the housing 210 close to the brush head 100. The circuit board 600 may be arranged, for example, between the motor 400 and the housing 210 in a transverse direction of the housing 210. In this way, the space in the housing 210 may be further saved, leading to a reduction in the size of the handle 200, and the handle 200 may be easily held by users without affecting the cleaning function, thus further improving the user experience. Of course, in other implementations, the battery 700 may be arranged between the airflow generating device 300 and the motor 400 in the longitudinal direction of the housing 210; or, the battery 700 and the airflow generating device 300 may be arranged side by side. All these arrangements fall within the protection scope of the application.

Specifically, a driving shaft 410, for example, may be arranged in the housing 210, and the driving shaft 410 may drive the bristles 111 of the brush head 100 to swing or rotate. The driving shaft 410 may be arranged, for example, in the motor 400. The driving shaft 410 may be arranged, for example, at the center of the motor 400. The driving shaft 410 comprises a first end 411 and a second end 412 opposite to the first end 411. The driving shaft 410 may be provided with, for example, a second airflow channel 210 extending from the first end 411 to the second end 412. The first end 411 of the driving shaft 410 is connected to the brush head 100, and the second end 412 of the driving shaft 410 is connected to the airflow output port 310 of the airflow generating device 300. The motor 400 drives the bristles 111 to swing or rotate by means of the driving shaft 410. The driving shaft 410 may be configured as, for example, a hollow structure to form the second airflow channel 201 in the driving shaft 410. An airflow generated by the airflow generating device 300 passes through the airflow output port 310, the second airflow channel 201 in the driving shaft 410 and the first airflow channel 101 in the brush head 100 to be sprayed out via the airflow hole 112. In this way, the oral cleaning device 10 has a simple structure while spraying out an airflow; and components in the housing 210 are arranged compactly, leading to a reduction in the size of the handle 200, such that the handle 200 can be easily held by users while the cleaning function is not affected, thus further improving the user experience.

Referring to FIG. 4, the airflow output port 310 and the second end 412 of the driving shaft 410 may be, for example, sleeved with a connecting tube 413, and the connecting tube 413 is tightly sleeved on the airflow output port 310 and the second end 412 of the driving shaft 410. The connecting tube 413 may be, for example, a flexible rubber hose. The connecting tube 413 may have, for example, an end disposed around the airflow output port 310 as well as another end disposed around the second end 412 of the driving shaft 410 to therefore connect the airflow output port 310 and the second airflow channel 201. In this way, the connection airtightness of the airflow output port 310 and the second airflow channel 201 may be improved, and disconnection between the airflow output port 310 and the driving shaft 410 caused by vibrations in operation of the motor 400 may be prevented, thus further improving the airflow transmission effect.

Further, the first end 411 of the driving shaft 410 is in airtight connection with the first airflow channel 101. “Airtight connection” refers to that the first end 411 of the driving shaft 410 and the first airflow channel 101 are connected together and the joint between the first end 411 and the first airflow channel 101 is airtight. In this way, the airtightness of the airflow channel is improved, and the airflow is output unidirectionally.

Specifically, the first end 411 of the driving shaft 410 may be provided with, for example, a scaling member 190. One end of the sealing member 190 is tightly disposed around the first end 411, and the other end of the sealing member 190 extends out of the driving shaft 410 and is received in the first airflow channel 101. The scaling member 190 may be, for example, a soft silicone hose. The silicone hose may, for example, have one end tightly disposed around the first end 411 of the driving shaft 410 and the other end tightly attached to inner surfaces of the first airflow channel 101, such that the airtightness of the airflow channel is improved, and the airflow is output unidirectionally. The first airflow channel 101 becomes narrower gradually in a direction from the motor 400 to the base 110a to further improve the airflow spraying effect, thereby improving the cleaning effect of the oral cleaning device 10. An end, close to the airflow hole 112, of the first airflow channel 101 may be further provided with, for example, a check valve to enable the airflow to be sprayed out unidirectionally to improve the airflow spraying effect, thereby further improving the cleaning effect of the oral cleaning device 10.

The first end 411 of the driving shaft 410 may be, for example, sleeved with a driving shaft locking member 150. The driving shaft locking member 150 is arranged on a side, close the motor 400, of the scaling member 190 and fixedly connected to the sealing member 190. The driving shaft locking member 150 may be arranged on the driving shaft 410, for example, by injection molding, then the scaling member 190 is arranged on the driving shaft 410 by injection molding, and the driving shaft locking member 150 and the scaling member 190 are fixedly connected. Of course, the driving shaft locking member 150 may be connected to the scaling member 190, for example, by bonding or in other ways. Referring to FIG. 5, an outer side, away from the driving shaft 410, of the driving shaft locking member 150 may be provided with, for example, a first locking portion 152, an end, away from the base 110a, of the brush head 100 is provided with a second locking portion 143, and the first locking portion 152 and the second locking portion 143 are detachably connected to detachably connect the handle 200 and the brush head 100.

In one specific implementation of this embodiment, the second airflow channel 201 may be arranged, for example, between the motor 400 and the housing 210 in the transverse direction of the housing 210. To be specific, the second airflow channel 201 may be, for example, an air duct arranged between the motor 400 and the housing 210, that is, the air duct and the motor 400 are arranged side by side in the transverse direction of the housing 210. One end of the air duct is connected to the airflow output port 310 of the airflow generating device 300, and the other end of the air duct is connected to the first airflow channel 101 of the brush head 100. In this way, an airflow generated by the airflow generating device 300 passes through the second airflow channel 201 and the first airflow channel 101 to be sprayed out via the airflow hole 112.

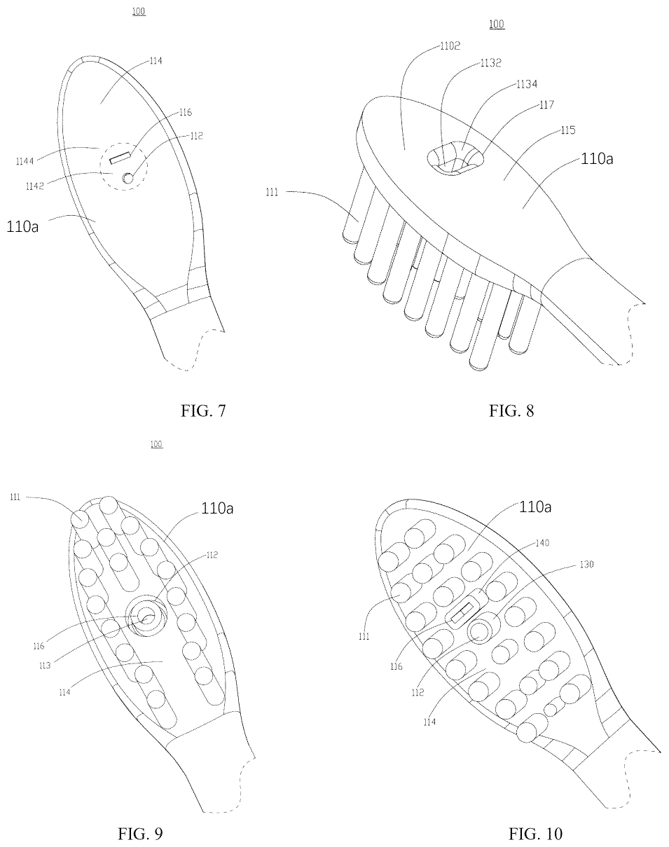

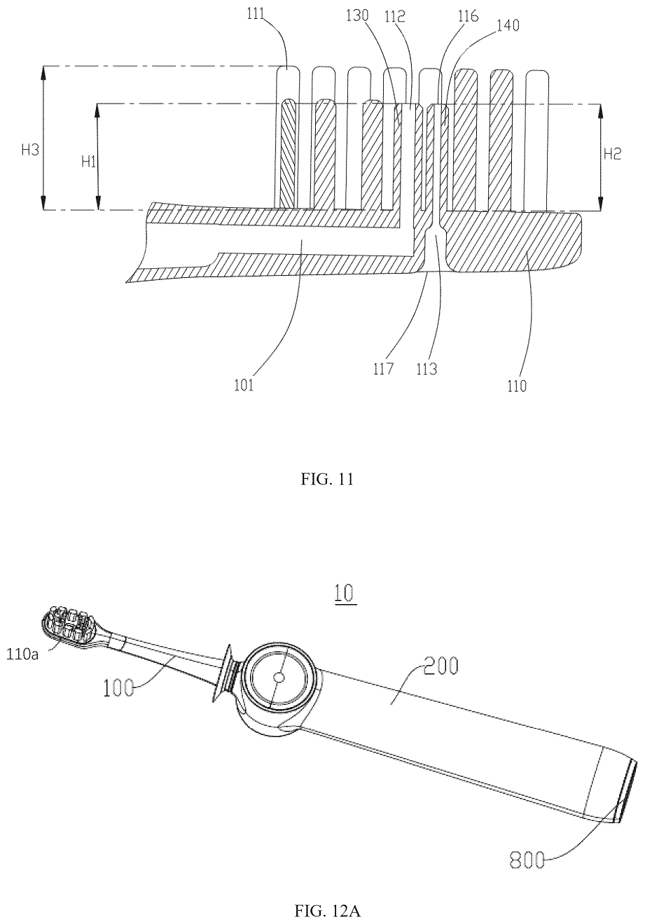

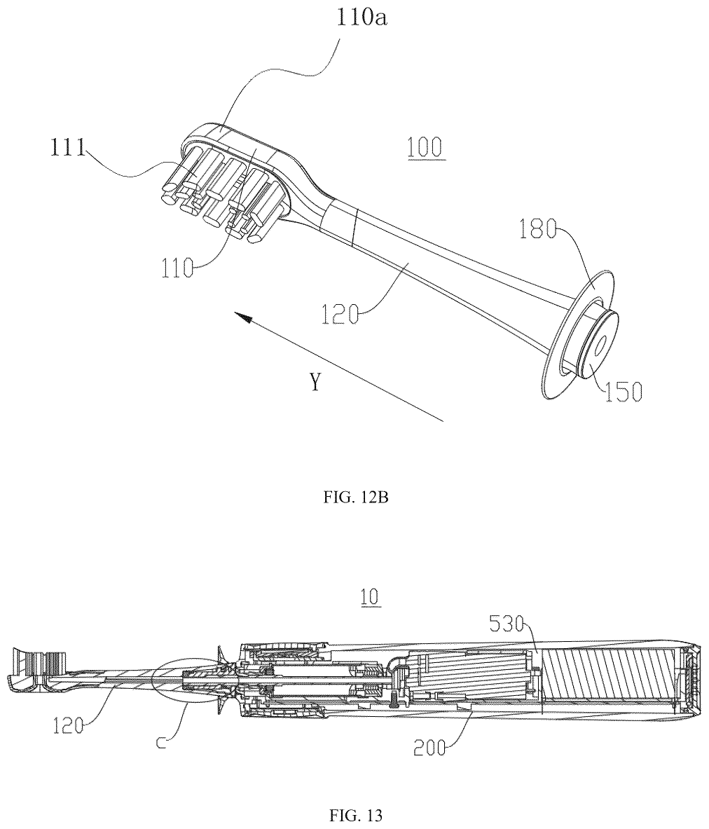

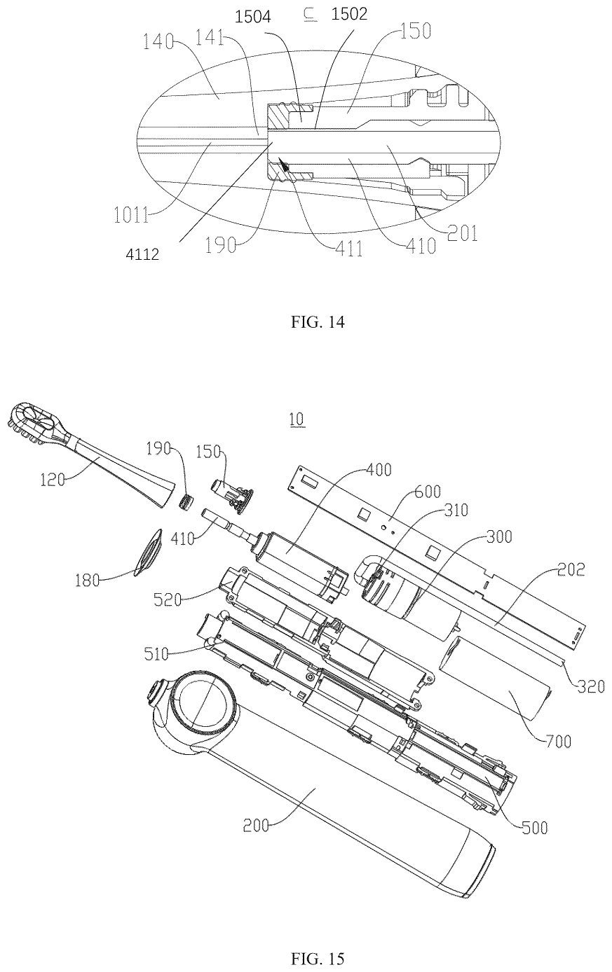

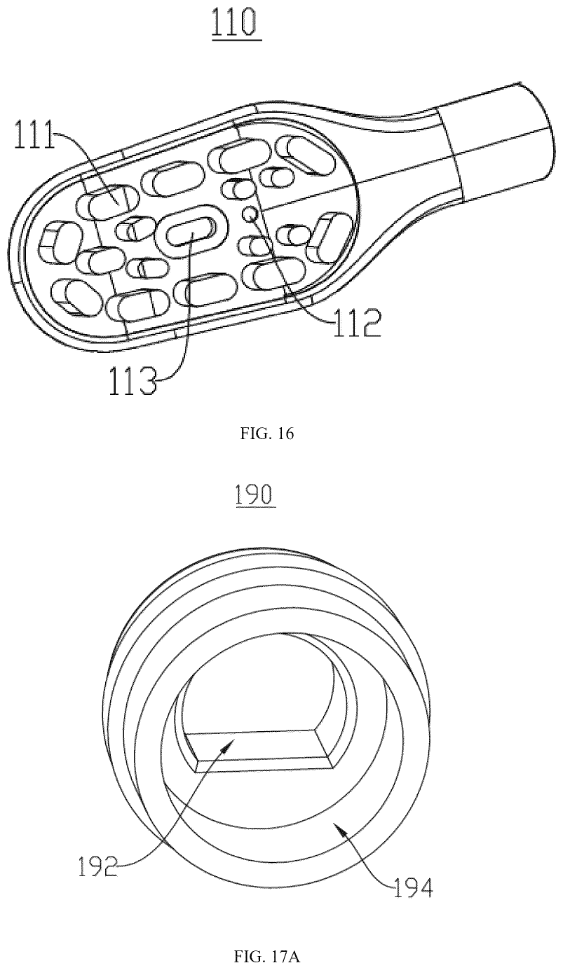

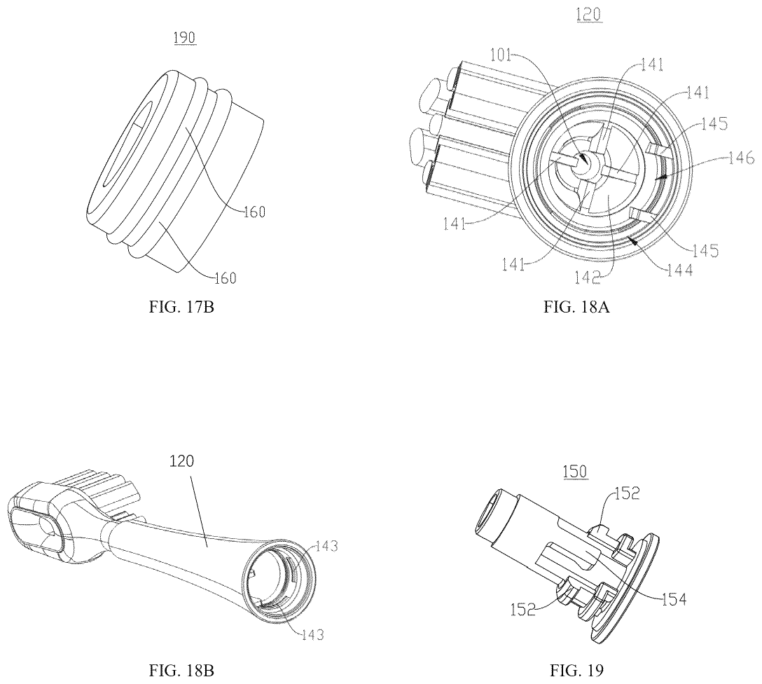

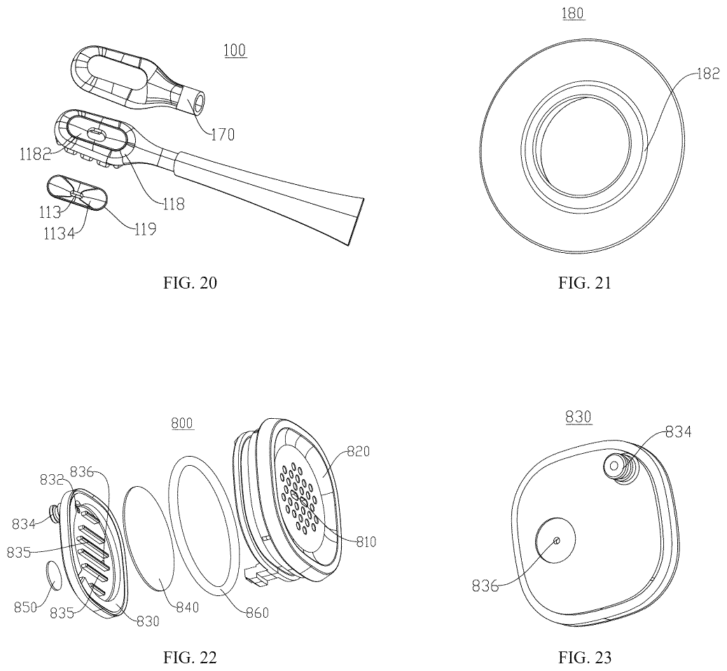

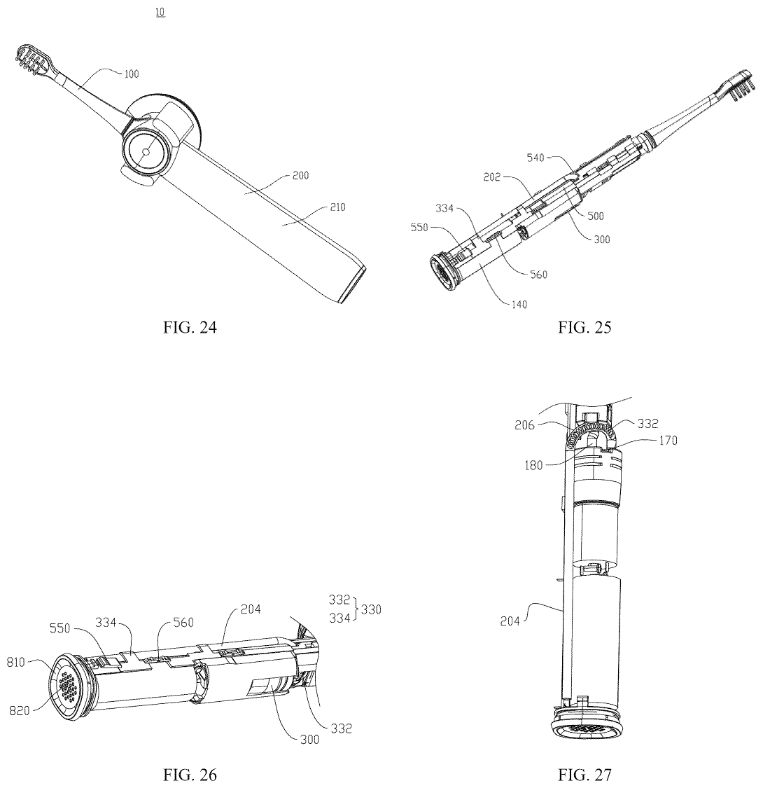

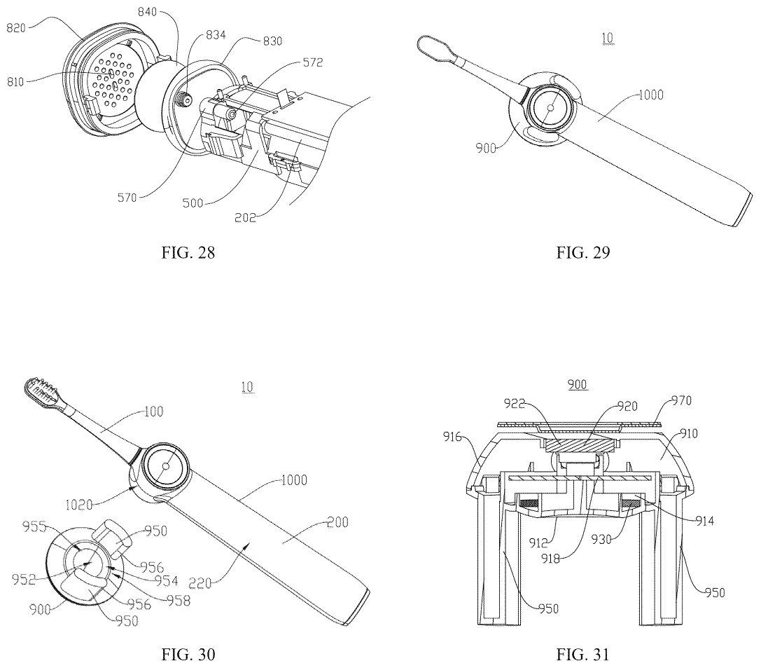

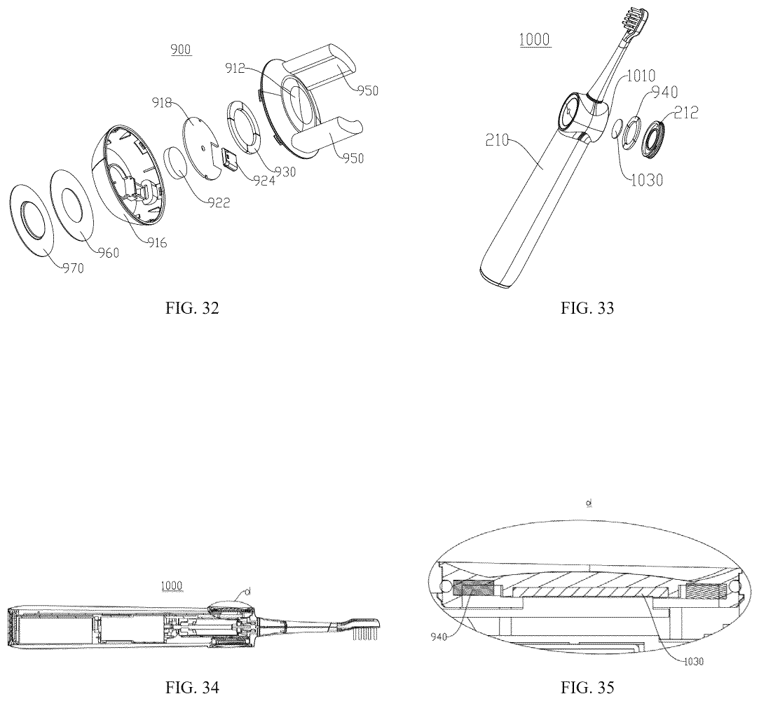

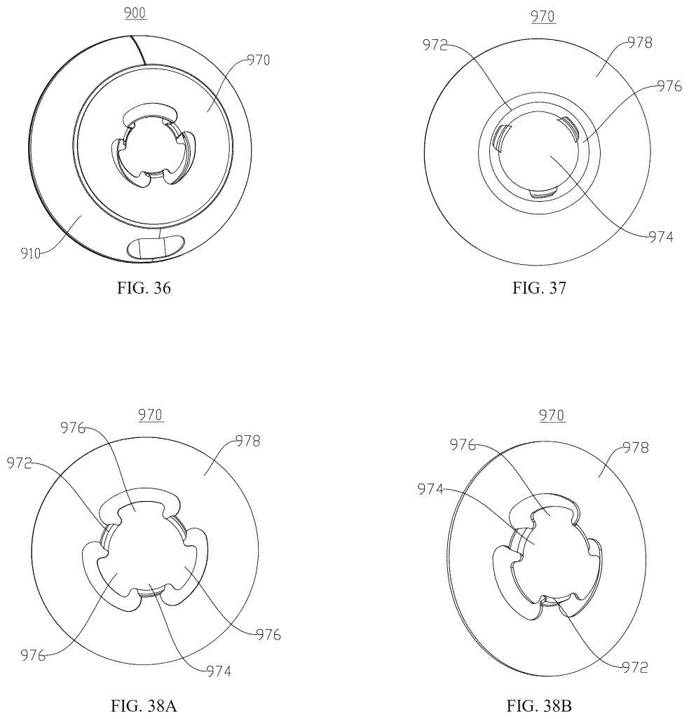

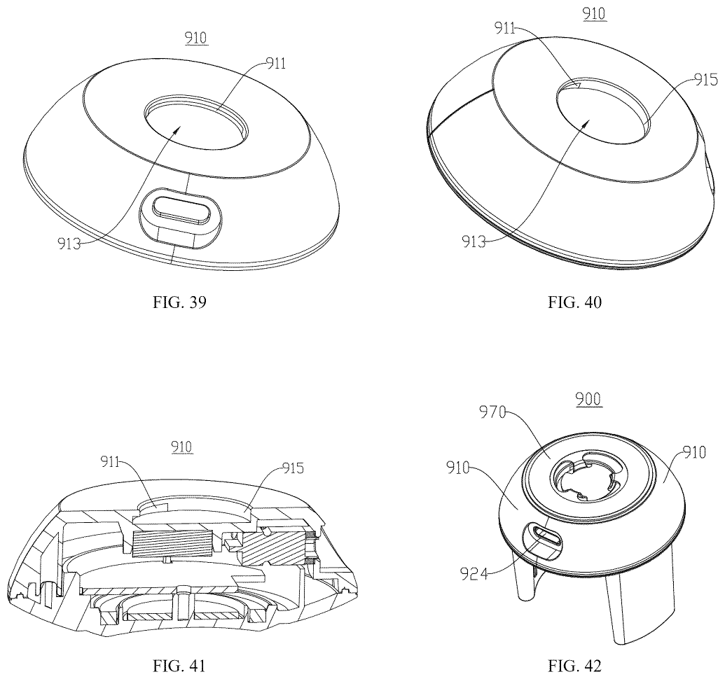

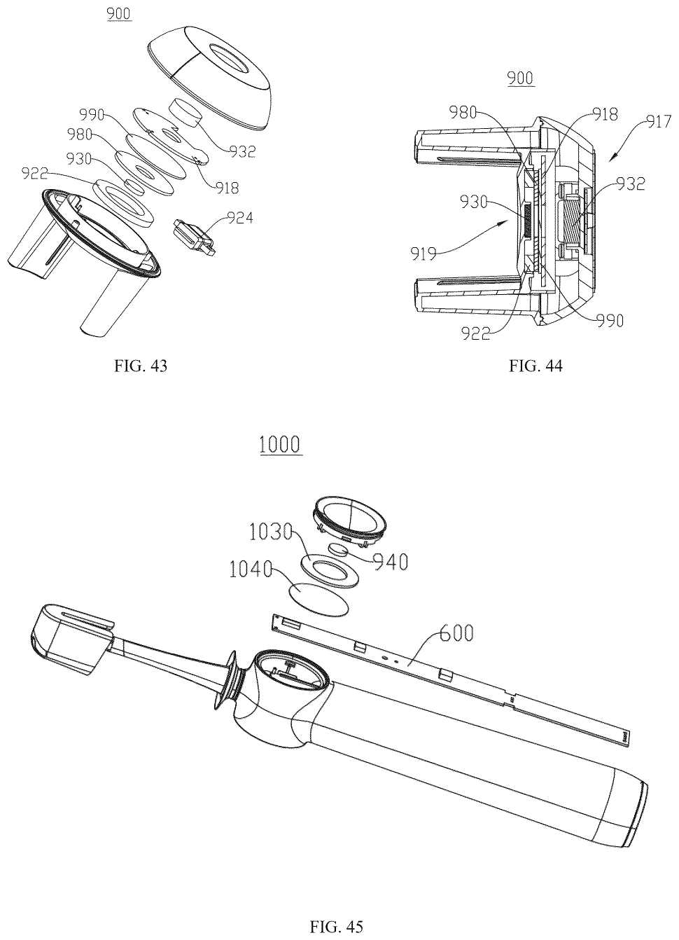

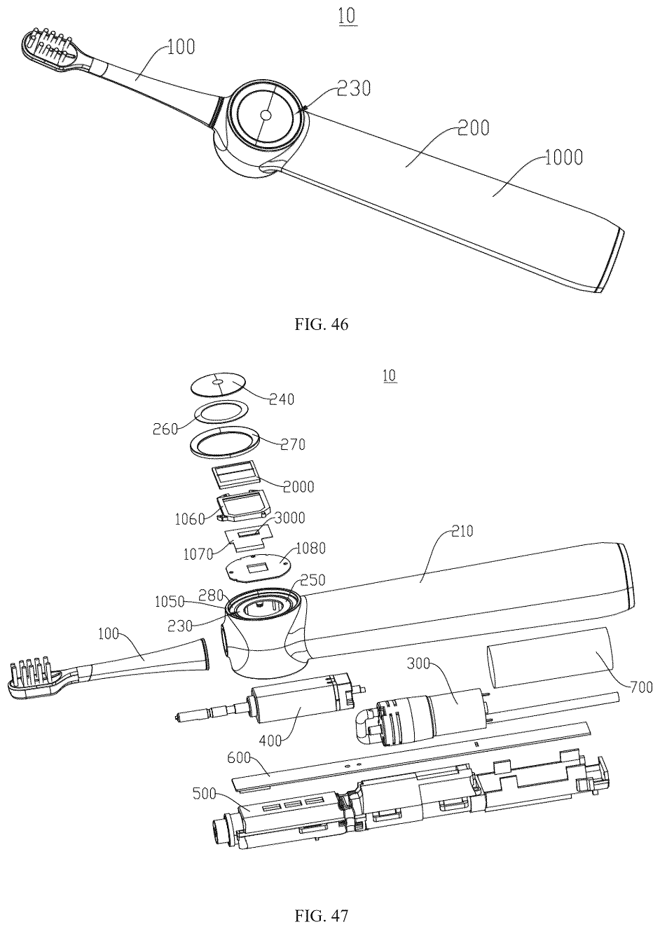

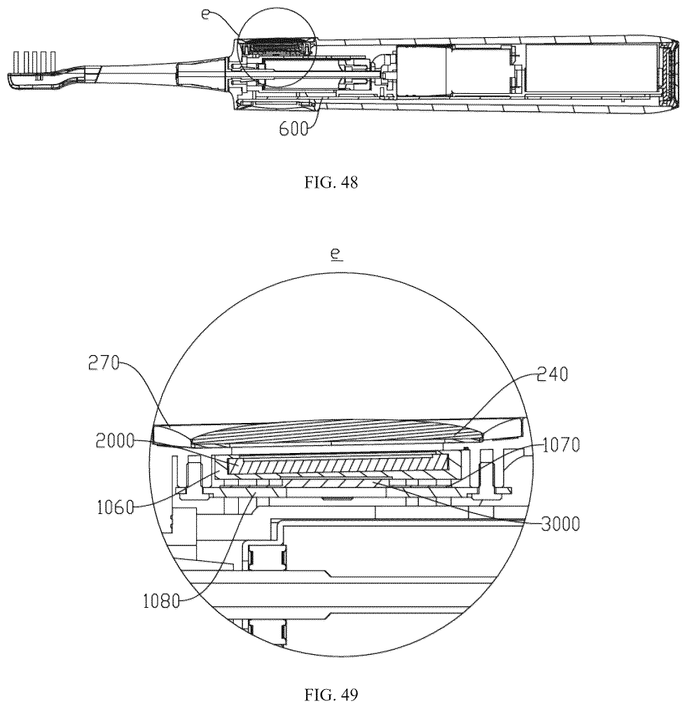

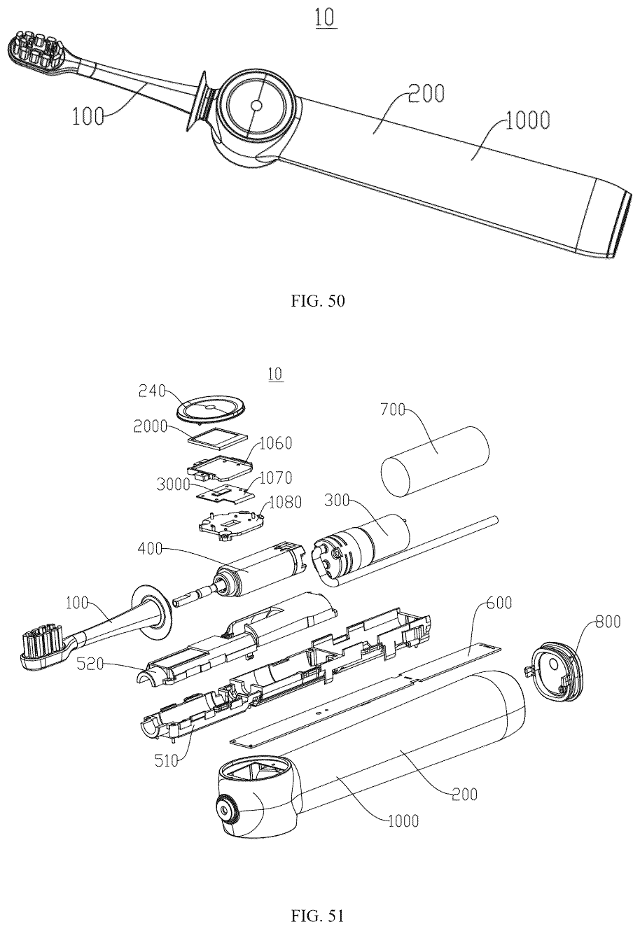

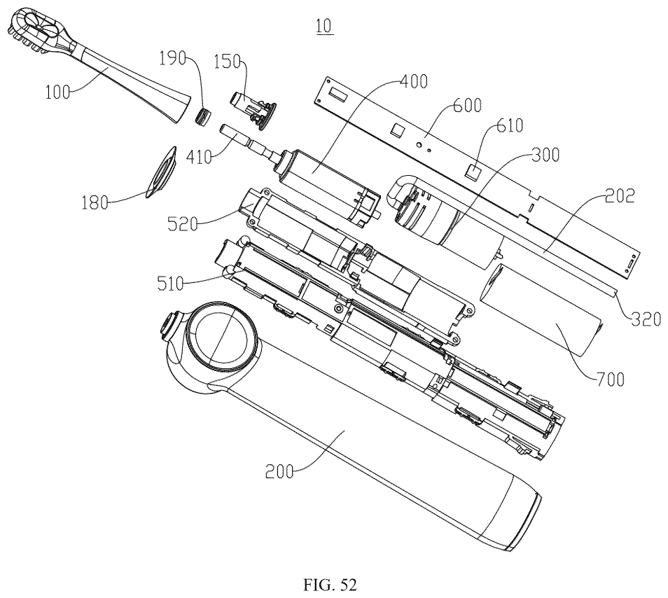

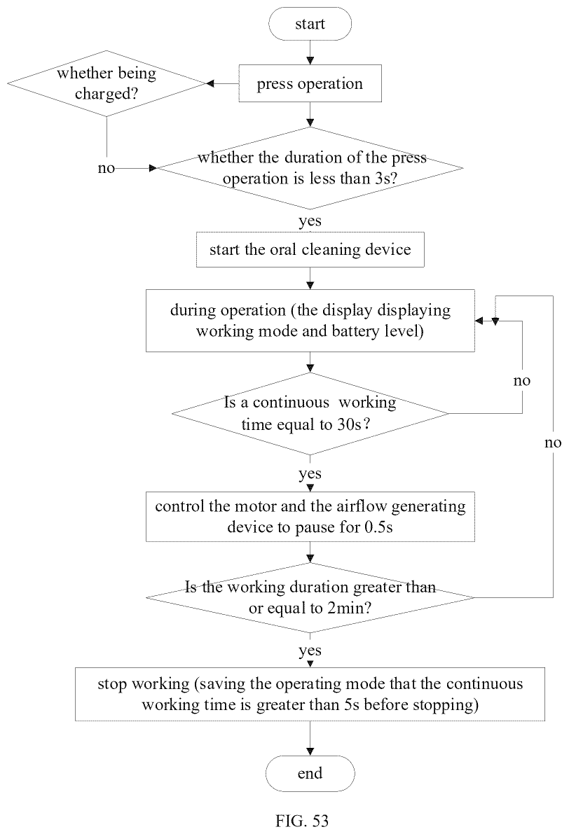

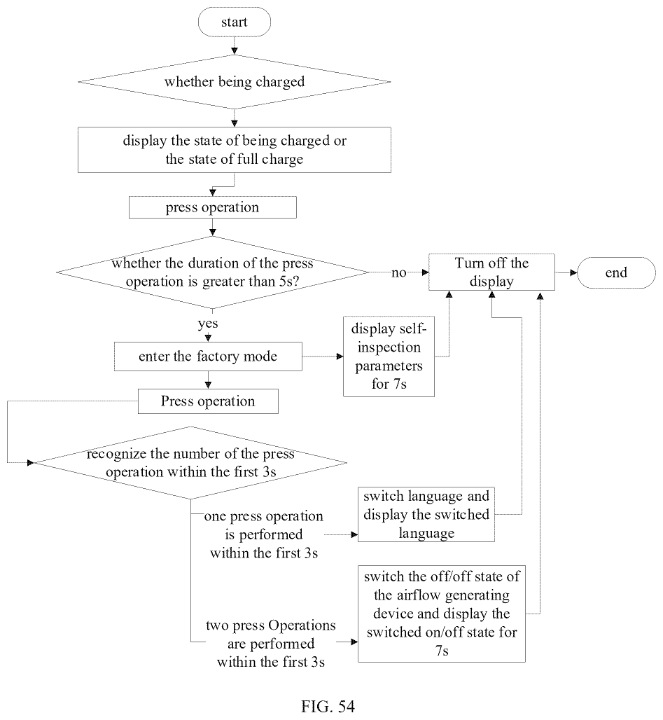

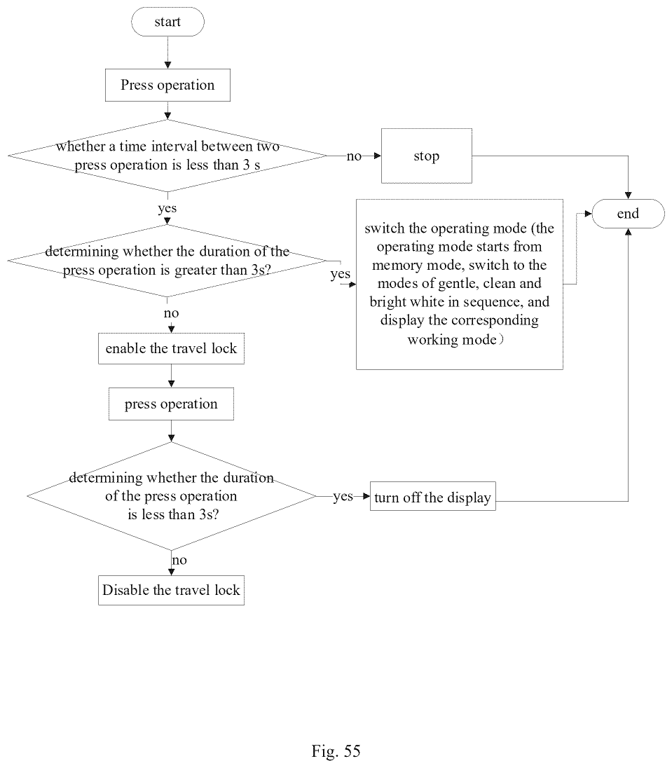

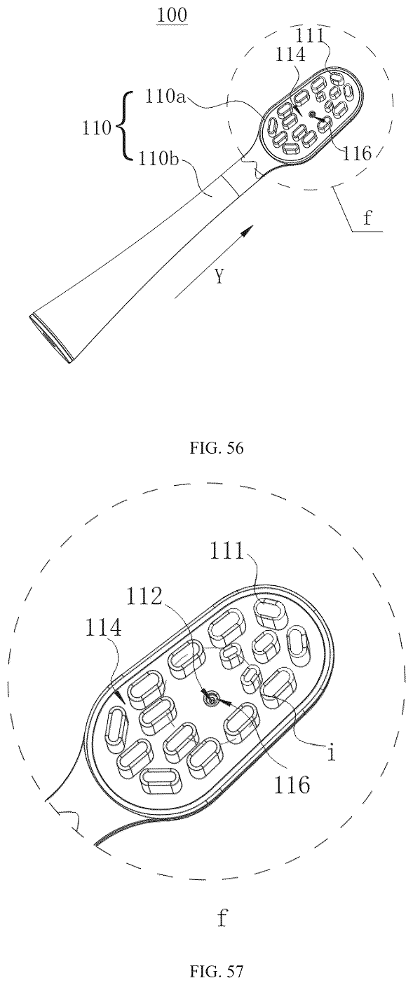

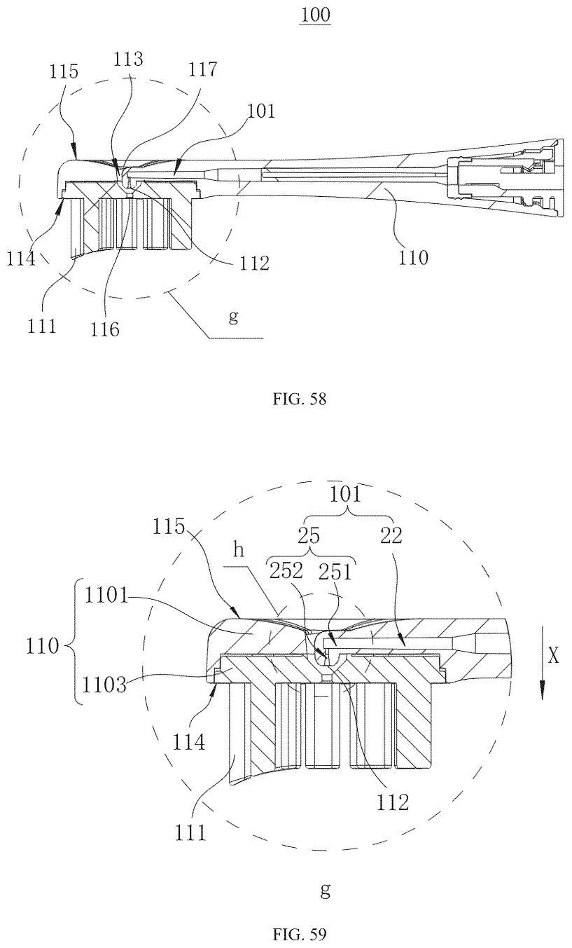

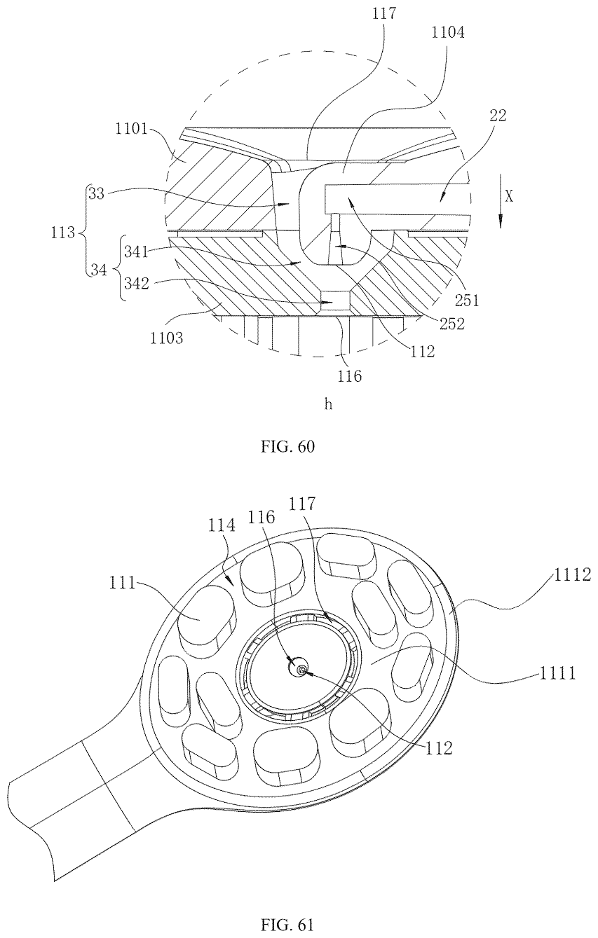

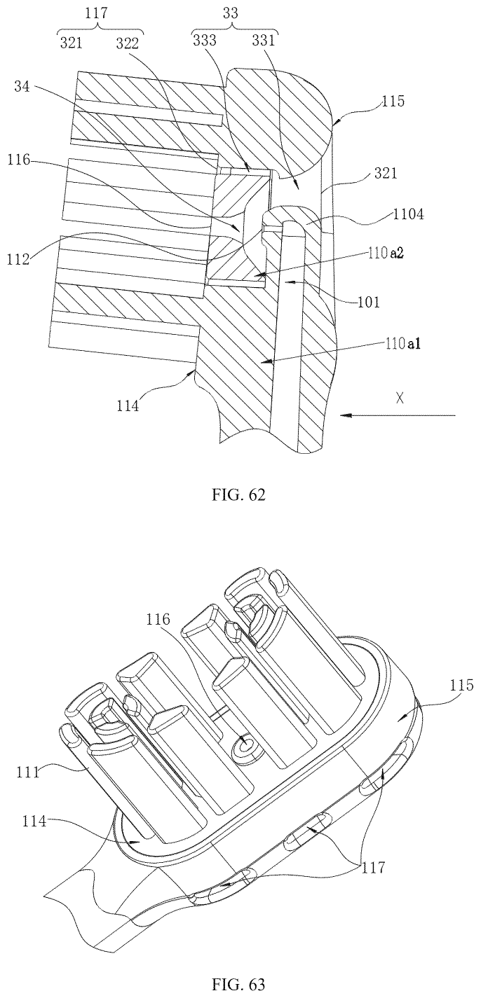

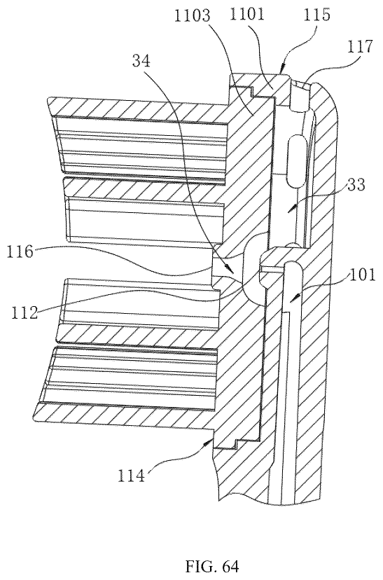

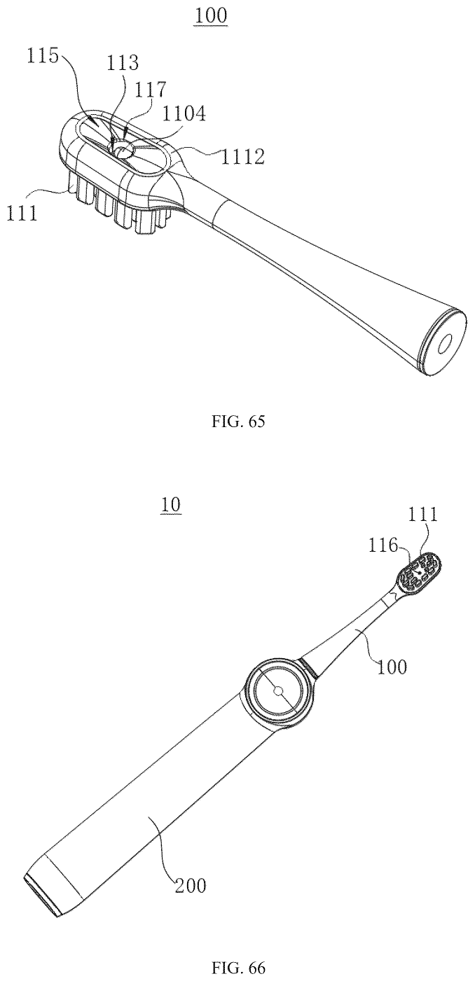

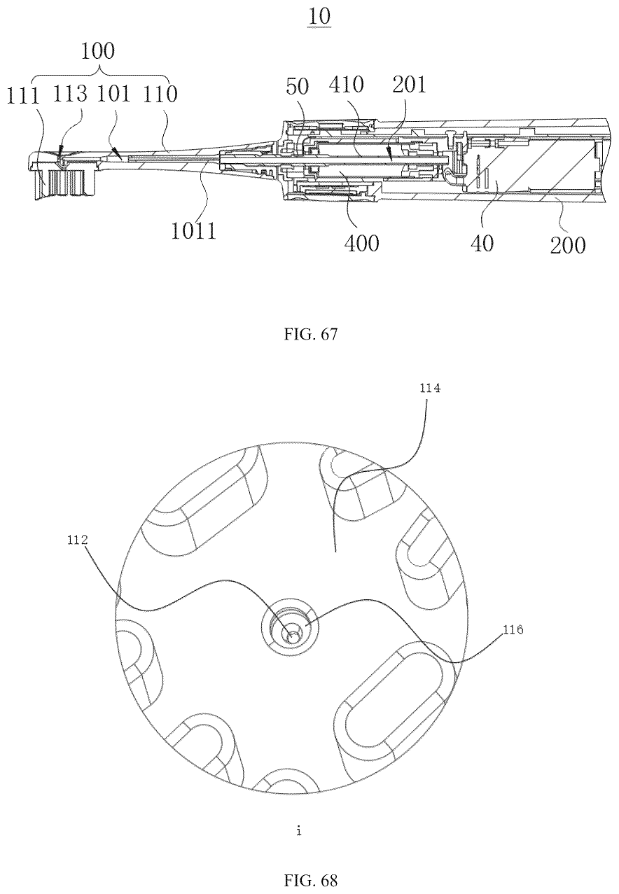

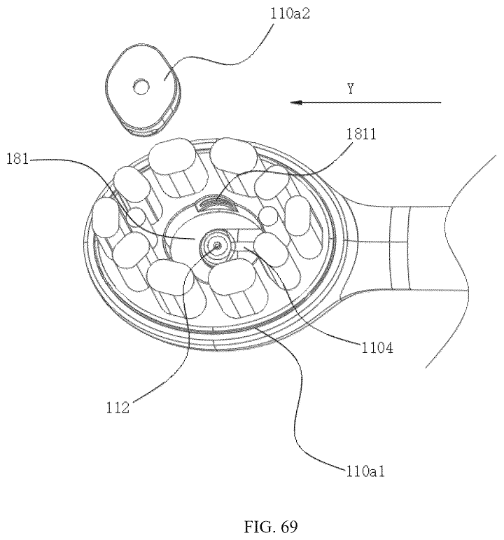

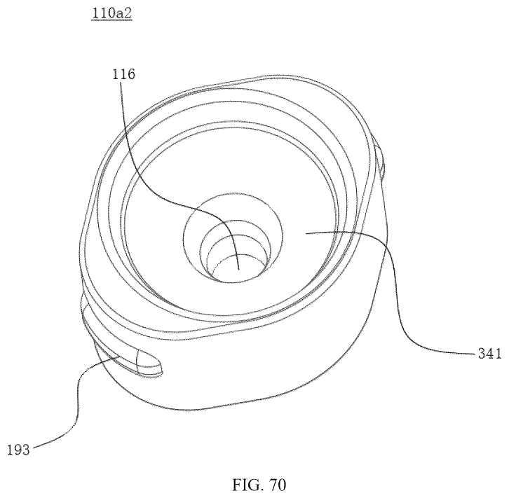

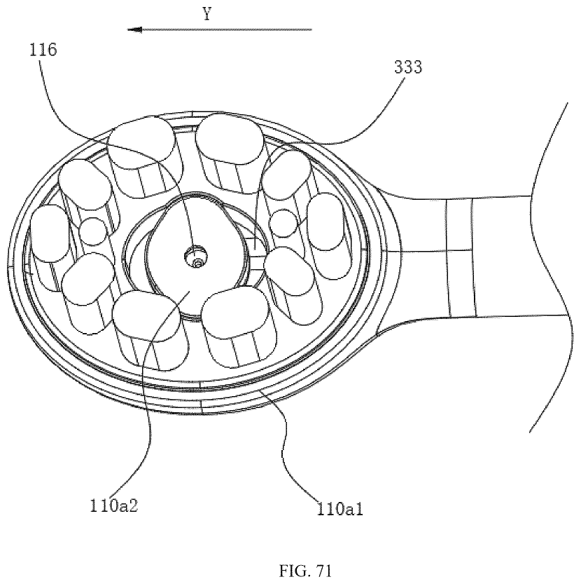

As shown in FIGS. 6-8, the oral cleaning device 10 of the application adopts another brush head 100, which is different from the abovementioned brush head 100 in that the base 110a of the another brush head 100 comprises a liquid guiding channel 113 penetrating therethrough, and one end of the liquid guiding channel 113 is located on the side, provided with the airflow hole 112, of the base 110a. Air flowing through the first airflow channel 101 is sprayed out via the airflow hole 112, a negative pressure region is formed around the airflow hole 112, and due to the liquid pressure of the brush head 100 close to the other end of the liquid guiding channel 113 is greater than the pressure in the negative pressure region, liquid in the vicinity of the brush head 100 is cyclically transported to the airflow hole 112 through the liquid guiding channel 113, air sprayed out from the airflow hole 112 is combined with the liquid on the side, facing teeth, of the brush head 100 to generate abundant bubbles, which are blown to surfaces of teeth and interdental gaps between adjacent teeth. The surfaces of teeth and the interdental gaps between adjacent teeth are cleaned by means of impact generated by instantaneous collapse and burst of the bubbles, such that the tooth cleaning effect is improved.

In this embodiment, the base 110a includes a first side 114 and a second side 115, and the first side 114 and the second side 115 are arranged adjacent or opposite to each other. The base 110a is provided with a first liquid guide port 116 and a second liquid guide port 117 which are respectively communicated with opposite two ends of the liquid guiding channel 113. The first liquid guide port 116, the airflow hole 112 and the bristles 111 are all arranged on the first side 114, and the second liquid guide port 117 is formed in the second side 115. Because the first side 114 and the second side 115 are arranged adjacent or opposite to each other, air sprayed out via the airflow hole 112 may drive part of liquid in the vicinity of the brush head 100 to sequentially pass through the second liquid guide port 117, the liquid guiding channel 113 and the first liquid guide port 116 to be continuously supplied to the vicinity of the airflow hole 112, such that the liquid is combined with the air to form abundant bubbles; and liquid, formed after the bubbles burst, cyclically flows to the vicinity of the airflow hole 112 through the second liquid guide port 117, the liquid guiding channel 113 and the first liquid guide port 116. The first liquid guide port 116 acts as a liquid outlet port 116 of the liquid guiding channel 113 and the second liquid guide port 117 acts as a liquid inlet port 117 of the liquid guiding channel 113. Optionally, the air outlet hole 112 of the first airflow channel 101 has a cross-sectional area less than that of the liquid outlet port 116 of the liquid guiding channel 113.

Specifically, a negative pressure region may be formed in the vicinity of the airflow hole 112, the first liquid guide port 116 is communicated with the negative pressure region, air flowing through the first airflow channel 101 is sprayed out from the airflow hole 112 and then squeezed by liquid to form spherical bubbles. Since air is continuously sprayed out from the airflow hole 112 and liquid in the vicinity of the second liquid guide port 117 is transported into the liquid guiding channel 113 and flows from the first liquid guide port 116 to the negative pressure region in the vicinity of the airflow hole 112, abundant bubbles may be continuously generated on the side, facing teeth, of the brush head 100, and interdental spaces are cleaned by means of impact generated by instantaneous collapse and burst of the bubbles.

In this embodiment, the first liquid guide port 116 and the second liquid guide port 117 are located at two opposite sides of the base 110a respectively. Since a large quantity of bubbles will be generated on the side, facing teeth, of the brush head 100, the bubbles will squeeze liquid and occupy the space of liquid and air sprayed out via the airflow hole 112 needs to be combined with liquid to generate new bubbles, the second liquid guide port 117 is located in a side, away from the first liquid guide port 116, of the base 110a, and liquid in the vicinity of the second liquid guide port 117 may be continuously supplied to a side, facing teeth, of the base 110a through the second liquid guide port 117, the liquid channel 13 and the first liquid guide port 116. In other embodiments, the second liquid guide port 117 may be formed in a side, adjacent to the first liquid guide port 116, of the base 110a, and by means of the second liquid guide port 117, liquid in the vicinity of the base 110a may be transported to the side, facing teeth, of the brush head 100 through the liquid guiding channel 113 and the first liquid guide port 116.

In this embodiment, the first side 114 is provided with a perforated region 1142 and an installation region 1144, the installation region 1144 is arranged around the perforated region 1142. The airflow hole 112 and the first liquid guide port 116 are located in the perforated region 1142, and the plurality of bristles 111 are arranged in the installation region 1144. By spacing the bristles 111 located in the installation region 1144 apart from the airflow hole 112 and the first liquid guide port 116 located in the perforated region 1142, the airflow hole 112 and the first liquid guide port 116 are prevented from being covered or interfered by the bristles 111, such that liquid may sequentially pass through the second liquid guide port 117, the liquid guiding channel 113 and the first liquid guide port 116 to be output to the side, facing teeth, of the base 110a, thus ensuring that air sprayed out via the airflow hole 112 may be combined with the liquid to generate abundant bubbles continuously.

In this embodiment, an inner surface 1132 of the liquid guiding channel 113 is connected to an outer surface 1102, provided with the second liquid guide port 117, of the base 110a by means of a guide surface 1134. The guide surface 1134 is a smooth curved surface to allow liquid to sequentially and smoothly flow through the outer surface 1102 of the base 110a, the guide surface 1134 and the liquid guiding channel 113. The smooth curved surface may reduce the resistance generated in the flowing process of liquid.

As shown in FIG. 9, the oral cleaning device 10 of the application adopts another brush head 100, which is different from the abovementioned brush heads 100 in that the airflow hole 112 of the brush head 100 as shown in FIG. 9 is ring-shaped and arranged around the first liquid guide port 116. After air in the first airflow channel 101 is blown out via the airflow hole 112, negative pressure regions are formed on an inner side and an outer side of the ring-shaped airflow hole 112 respectively, liquid in the negative pressure region on the inner side of the airflow hole 112 is consumed by being continuously combined with the air to generate bubbles. Since the first liquid guide port 116 is surrounded by the airflow hole 112 and the second liquid guide port 117 is located in the second side, liquid may be guided into the liquid guiding channel 113 by means of the second liquid guide port 117, and liquid in the liquid guiding channel 113 is transported to the negative pressure region on the inner side of the ring-shaped airflow hole 112 by means of the first liquid guide port 116, such that liquid is continuously supplied to the negative pressure region on the inner side of the ring-shaped airflow hole 112 to ensure that air sprayed out from the airflow hole 112 may be continuously squeezed by the liquid output from the first liquid guide port 116 to form spherical bubbles.

In another embodiment of the application, a plurality of airflow holes 112 are arranged around the first liquid guide port 116, wherein the plurality of airflow holes 112 may be arranged in order, or the plurality of airflow holes 112 may be arranged out of order.

As shown in FIGS. 10 and 11, the oral cleaning device 10 of the application adopts another brush head 100, which is different from the abovementioned brush heads 100 in that the brush head 100 as shown in FIGS. 10 and 11 further includes a first extension portion 130 and a second extension portion 140. The first extension portion 130 and the second extension portion 140 are connected to the same side of the base 110a. The airflow hole 112 is formed in the first extension portion 130. The first liquid guide port 116 is formed in the second extension portion 140. One part of the first airflow channel 101 is arranged in the base 110a, and the other part of the first airflow channel 101 is arranged in the first extension portion 130. One part of the liquid guiding channel 113 is arranged in the base 110a, and the other part of the liquid guiding channel 113 is arranged in the second extension portion 140. By arranging the first extension portion 130 and the second extension portion 140, decreasing distances from ends of the airflow hole 112 and the first liquid guide port 116 to interdental spaces and decreasing distances from ends of the airflow hole 112 and the first liquid guide port 116 to tooth surfaces, bubbles formed after air sprayed out from the airflow hole 112 is combined with liquid may be quickly adhered to the tooth surfaces and the interdental spaces, thus ensuring that the tooth surfaces and the interdental spaces are effectively cleaned by means of impact generated by instantaneous collapse and burst of more bubbles.

In this embodiment, a height of the first extension portion 130 protruding out of the surface of the base 110a is H1, a height of the second extension portion 140 protruding out of the surface of the base 110a is H2, and a height of the bristles 111 protruding out of the surface of the base 110a is H3, wherein 0 cm<H1<H3, and 0 cm<H2<H3. In a case where H1 satisfies 0 cm<H1<H3 and H2 satisfies 0 cm<H2<H3, when the bristles 111 come into contact with teeth for cleaning, a space exists between the first extension portion 130 and the tooth surfaces to ensure that air sprayed out from the airflow hole 112 may be smoothly combined with liquid to generate bubbles, and a space exists between the second extension portion 140 and the tooth surfaces to ensure that liquid flowing out from the first liquid guide port 116 can be combined with the air sprayed out from the airflow hole 112 to form bubbles.

In this embodiment, the first extension portion 130 is made from a flexible material. The first extension portion 130, when coming into contact with tooth surfaces, may deform to avoid rigid collisions between the first extension portion 130 and teeth, which may otherwise cause discomfort of the oral cavity.

In this embodiment, the second extension portion 140 is made from a flexible material. The second extension portion 140, when coming into contact with tooth surfaces, may deform to avoid rigid collisions between the second extension portion 140 and teeth, which may otherwise cause discomfort of the oral cavity.

In this embodiment, the first extension portion 130 and the second extension portion 140 are both made from a flexible material, such that the first extension portion 130 and the second extension portion 140 may gently clean tooth surfaces.

In another embodiment of the application, the brush head 100 further includes an enclosure portion. The enclosure portion is connected to the first side 114 and encloses the airflow hole 112 and the first liquid guide port 116, and a negative pressure region may be formed around the airflow hole 112 and located in a region defined and surrounded by the enclosure portion. Specifically, the enclosure portion is ring-shaped and surrounds the airflow hole 112 and the first liquid guide port 116 to prevent the negative pressure region formed around the airflow hole 112 when air is sprayed out from the airflow hole 112 from being excessively divergent, and the enclosure portion may also prevent the negative pressure region from being affected by the liquid pressure outside the enclosure portion and may guide the air sprayed out from the airflow hole 112 to enhance the negative pressure region formed around the gas so as to guide liquid in the vicinity of the brush head 100 to pass through the liquid guiding channel 1132 and be transported into the negative pressure region from the first liquid guide port 116.

Referring to FIGS. 12A-15, a second embodiment of the present application provides an oral cleaning device 10, which is different from the oral cleaning device 10 in the above embodiment in that, in this embodiment, the brush head 100 includes a shell 110 which comprises a base/head portion 110a on which the bristles 111 are mounted, a body portion 120 extending from the base/head portion 110a in a length direction Y of the brush head 110 and a scaling member 190.

Referring to FIG. 14, a limiting portion 141 is arranged on an inner wall of the brush head body 120. The driving shaft 410 is inserted and connected into the body portion 120, and the limiting portion 141 is located at an insertion path of the driving shaft 410. When the driving shaft 410 is inserted into the body portion 120, the driving shaft 410 is inserted into a preset position determined by means of the limiting portion 141 to make the first airflow channel 101 communicate with the second airflow channel 201. The scaling member 190 may be, for example, a rubber member, a silicone member or other elastically deformable structural members. The scaling member 190 is connected between the driving shaft 410 and the body portion 120 in a scaling manner to realize scaled communication between the first airflow channel 101 and the second airflow channel 201. By arranging the sealing member 190 between the driving shaft 410 and the brush head body 120 to realize the sealed communication between the first airflow channel 101 and the second airflow channel 201, the sealing performance of the joint between the first airflow channel 101 and the second airflow channel 201 is improved to ensure the airflow or liquid spraying effect, thus improving the cleaning effect of the oral cleaning device 10. In addition, by arranging the limiting portion 141 in the body portion 120, the driving shaft 410, when inserted into the body portion 120, may be inserted into the preset position in the brush head 140 determined by means of the limiting portion 141, thus further improving the sealing performance of the first airflow channel 101 and the second airflow channel 201.

Referring to FIG. 15, the airflow generating device 300 is provided with an airflow input port 320 and an airflow output port 310. The support 500 includes a first mounting frame 510 and a second mounting frame 520. An electronic element receiving cavity 530 is formed by the first mounting frame 510 and the second mounting frame 520. The airflow generating device 300, the motor 400, the circuit board 600 and the battery 700 are all arranged in the electronic element receiving cavity 530. The battery 700 is electrically connected to the airflow generating device 300, the motor 400 and the circuit board 600 and configured to supply power to the airflow generating device 300, the motor 400 and the circuit board 600. The oral cleaning device 10 may be further provided with, for example, a switch, and the switch is connected to the circuit board 600. Of course, this embodiment is not limited to such an arrangement.

Further, the brush head 100 further includes a driving shaft locking member 150. The driving shaft locking member 150 is connected into the brush head body 120 and disposed around the driving shaft 410 to be connected to the driving shaft 410, such that the brush head 100 and the handle 200 are detachably connected. Specifically, the driving shaft 410 may have, for example, a first end 411 close to the limiting portion 141. The driving shaft locking member 150 is disposed around the first end 411 of the driving shaft 410. The first end 411 of the driving shaft 410 comprises a protruding portion 4112 protruding out of the driving shaft locking member 150. The driving shaft locking member 150 is connected into the body portion 120. Specifically, the end of the body portion 120 away from the bristles 111 defines a receiving opening and the driving shaft locking member 150 is received in the receiving opening. The driving shaft locking member 150 defines a mounting hole 1502 in communication with the first airflow channel 101, and the driving shaft 410 of the vibration motor 400 is inserted into the mounting hole 1502 with the protruding portion 4112 extending beyond the mounting hole 1502. The scaling member 190 is sandwiched between the limiting portion 141 and the locking member 150. The scaling member 190 is disposed around a connecting end 1504 of the driving shaft locking member 150 and the protruding portion 4112 of the driving shaft 410 and connected to the body portion 120 in a scaling manner.

Referring to FIGS. 17A and 17B, the scaling member 190 is provided with a driving shaft connecting portion 192 and a locking member connecting portion 194. The locking member connecting portion 194 extends axially from a periphery of the driving shaft connecting portion 192. The driving shaft connecting portion 192 may, for example, match the protruding portion 4112 of the driving shaft 410 in structure, and the locking member connecting portion 194 may, for example, match the connecting end 1504 of the driving shaft locking member 150 in shape. The driving shaft connecting portion 192 is disposed around the protruding portion 4112 in a scaling manner, and the locking member connecting portion 194 is disposed around the connecting end 1504 of the driving shaft locking member 150, such that the scaling member 190 is connected to and seals the driving shaft 410 and the driving shaft locking member 150. The sealing member 190 is arranged in the receiving opening of the body portion 120, and an outer wall of the scaling member 190 may be, for example, attached to an inner wall of the receiving opening of the body portion 120, such that the sealing member 190 is connected to the body portion 120 in a sealing manner. Specifically, one or more scaling rings 160 may be arranged, for example, on the outer wall, close to the body portion 120, of the sealing member 190, and the scaling rings 160 are connected to and seal the inner wall of the body portion 120, such that the scaling member 190 is connected to the body portion 120 in a sealing manner. When the driving shaft 410 is inserted into the preset position in the body portion 120, the sealing member 190 may be tightly connected between the body portion 120 and the driving shaft 410 to realize the sealed communication between the first airflow channel 101 and the second airflow channel 201.

In one specific implementation of this embodiment, referring to FIG. 18A, a plurality of limiting portions 141, for example, may be arranged on the inner wall of the body portion 120 at intervals. By means of the plurality of limiting portions 141, the driving shaft 410 may be better limited when being mounted. The limiting portions 141 may be, for example, protrusions extending from the inner wall, and the limiting portions 141 and the body portion 120 may be configured as, for example, an integrated structure. Of course, this embodiment is not limited to such an arrangement. A hollow portion 142 is arranged between any two adjacent limiting portions 141 of the plurality of limiting portions 141. In this way, the strength of the side wall of the body portion 120 is improved, and shrinkage of the side wall of the body portion 120 is reduced; and at the same time, the weight of the body portion 120 is reduced, materials are saved, and the cost is reduced.

Referring to FIGS. 18B and 19-20, a first locking portion 152 is arranged on a side, away from the driving shaft 410, of the driving shaft locking member 150, that is, the first locking portion 152 is arranged on an outer side of the driving shaft locking member 150. A second locking portion 143, corresponding to the first locking portion 152, is arranged on the inner wall of the body portion 120. The driving shaft locking member 150 is detachably connected to the body portion 120 by engagement of the first locking portion 152 and the second locking portion 143. The first locking portion 152 may be, for example, an clastic protrusion, and the second locking portion 143 may be, for example, a groove. When the driving shaft locking member 150 enters the body portion 120, the clastic protrusion may be, for example, squeezed and deformed to enter the groove under the action of an external force and then restore to be clamped in the groove. Of course, the first locking portion 152 may be, for example, a groove, and the second locking portion 143 may be, for example, a protrusion. This embodiment has no limitation in this aspect.

Referring to FIGS. 18B and 19 again, in one specific implementation of this embodiment, the driving shaft locking member 150 is provided with a driving shaft fastening portion 154 connected to the driving shaft 410. A communicating port 144 is formed in an end, away from the base 110, of the body portion 120. The driving shaft locking member 150 enters the body portion 120 via the communicating port 144 to be connected to the body portion 120. Two guide protrusions 145 are arranged on the inner wall, close to the communicating port 144, of the body portion 120, a guide portion 146 is formed between the two guide protrusions 145, the driving shaft fastening portion 154 is located between the two guide protrusions 145, and the guide portion 146 is arranged corresponding to the driving shaft fastening portion 154. The two guide protrusions 145 may guide the driving shaft locking member 150 to enter the body portion 120 according to a proper angle to prevent a connection failure of the body portion 120 and the driving shaft locking member 150 caused by an improper direction and to ensure that the driving shaft 410 is reliably and detachably connected to the driving shaft fastening portion 154 after being inserted into the body portion 120, thus improving the case and accuracy of connection, reducing the operation difficulty for users and further improving the user experience.

In one implementation of this embodiment, the base 110a may include, for example, a main body part 118 and a guide member 119. The liquid guiding channel 113 and the guide surface 1134 are arranged on the guide member 119. A mounting recess 1182, for example, may be formed in the main body part 118, and the guide member 119 is connected to the main body part 118 by means of the mounting recess 1182. That is, the guide member 119 is mounted in the mounting recess 1182. In some embodiments, the guide member 119 and the main body part 118 may be, for example, formed integrally, and the guide member 119 and the main body part 118 may be formed integrally, for example, by secondary injection molding. A soft flexible part such as a rubber part 170 is arranged on an outer side, away from the first airflow channel 101, of the base 110a. The flexible part 170 may be made from, for example, silicone, rubber or other flexible materials. The flexible part 170 is sleeved on the outer side of the main body part 118 of the base 110a and configured to contact with the oral cavity of users in use, such that the comfort in use is improved, and the user experience is further improved.

Referring to FIGS. 12B, 16 and 21, in one specific implementation of this embodiment, a retainer ring 180, for example, may be arranged on an outer side of the end, away from the base 110a, of the body portion 120, and a liquid storage portion 182 is arranged on a side, close to the base 110a, of the retainer ring 180. The retainer ring 180 may be made from, for example, a flexible material. The retainer ring 180 may be, for example, a ring structure, and an inner ring portion of the ring structure is disposed around the body portion 120. Because the diameter of the body portion 120 may, for example, increase gradually from top to bottom, the retainer ring 180 is tightly connected to the body portion 120. The retainer ring 180 comprises a connecting portion connecting with the body portion 120 and a ring-shaped retaining portion which extends upwardly and outwardly from the connecting portion to thereby form the liquid storage portion 182. Of course, this embodiment is not limited to such an arrangement. By means of the retainer ring 180, when users use the oral cleaning device 10 to brush teeth, liquid flowing down along the brush head will be blocked by the retainer ring 180 and stored in the liquid storage portion 182, and the liquid in the liquid storage portion 182 can be poured out after use, such that the situation where the liquid flows onto the handle 200 and stains the hands of the users or flows into the handle 200 and damages electronic elements mounted in the handle 200 is avoided, thus improving the safety.

Referring to FIGS. 22 and 23, the oral cleaning device 10 may further include, for example, a waterproof air inlet cap assembly 800. The waterproof air inlet cap assembly 800 is connected to and seals the handle 200 and is provided with a first air inlet 810. Air flowing in via the first air inlet 810 enters the airflow generating device 300 via the airflow input port 320, and an airflow is generated. The airflow enters the second airflow channel 201 in the driving shaft 410 via the airflow output port 310, passes through the first airflow channel 101 in the body portion 120 and is sprayed out via the airflow hole 112. The waterproof air inlet cap assembly 800 may prevent water from entering the electronic element receiving cavity 530 via the first air inlet 810 to protect electronic elements in the oral cleaning device 10 against damage, thus improving the safety of the oral cleaning device 10. The waterproof air inlet cap assembly 800 may also prevent moisture from entering the electronic element receiving cavity 530 to prevent molds to thereby ensure that the airflow generating device 300 outputs a healthy and pollution-free airflow, which may otherwise affect the hygiene and health of users.

The waterproof air inlet cap assembly 800 may include, for example, an air inlet cap 820, a cover 830 and a first waterproof and air-permeable member 840. The air inlet cap 820 is connected to and seals the handle 200, the first air inlet 810 is formed in the air inlet cap 820, and the first air inlet 810 may be, for example, a plurality of through holes. The cover 830 is configured to cover the electronic element receiving cavity 530 and is provided with a second air inlet 832. An air inlet port 834 communicated with the airflow input port 320 is formed in a side, away from the air inlet cap 820, of the cover 830, and the air inlet port 834 is communicated with the second air inlet 832. The first waterproof and air-permeable member 840 is arranged on a side, close the air inlet cap 820, of the cover piece 840. The first waterproof and air-permeable member 840 may be, for example, a waterproof and air-permeable membrane, which may prevent moisture from entering the electronic element receiving cavity 530 to avoid molds, such that the airflow generating device 300 outputs a healthy and pollution-free airflow and prevent from affecting the hygiene and health of users.

Further, a plurality of ribs 835 are arranged on the side, close to the air inlet cap 820, of the cover 830. The plurality of ribs 835 are arranged at intervals such that an air passage is formed between every two adjacent ribs 835. The first waterproof and air-permeable member 840 is arranged on sides, close to the air inlet cap 820, of the plurality of ribs 835. When the first waterproof and air-permeable member 840 covers the cover 830, the ribs 835 may prevent the second air inlet 832 from being covered by the first waterproof and air-permeable member 840, which may otherwise compromise the air inlet effect.

The cover 830 may be provided with, for example, a fourth air inlet 836, and the fourth air inlet 836 is communicated with the electronic element receiving cavity 530. The waterproof air inlet cap assembly 800 further includes a second waterproof and air-permeable member 850. The second waterproof and air-permeable member 850 is arranged on a side, away from the air inlet cap 820, of the cover 830 and covers the fourth air inlet 836. The second waterproof and air-permeable member 850 may be, for example, a waterproof and gas-permeable membrane. By means of the fourth air inlet 836, air circulation between the electronic element receiving cavity 530 and the outside is realized to prevent an imbalance between the air pressure in the electronic element receiving cavity 530 and the air pressure outside the electronic element receiving cavity 530, which may otherwise cause damage to electronic elements. In addition, the second waterproof and air-permeable member 850 may prevent liquid from entering the electronic element receiving cavity 530, which may otherwise cause damage to electronic elements in the oral cleaning device 10. The waterproof air inlet cap assembly 800 may further include, for example, a sealing and connecting ring 860 connected between the air inlet cap 820 and the cover 830 to further improve the sealing performance at the joint between the air inlet cap 820 and the cover 830.

Referring to FIGS. 24-28, a third embodiment of the application provides an oral cleaning device 10, which is different from the oral cleaning device 10 in the above embodiments in that, in this embodiment, the oral cleaning device 10 further includes a protection structure 330 connected to the air inlet tube 202. The protection structure 330 may prevent the air inlet tube 202 from bending to thereby ensure stable output of an airflow of the oral cleaning device 10, thus improving the practicability and stability in use of the oral cleaning device 10 and guaranteeing the effectiveness of the functions of the oral cleaning device 10.

In an illustrative embodiment, the air inlet tube 202 includes an extension section 204 and a bent section 206 connected to the extension section 204. The protection structure 330 further includes a support member 332, and the support member 332 is connected to the extension section 204 and/or the bent section 206.

For example, the support member 332 is arranged on the support 500 and connected to the air inlet tube 202 in an extension direction of the air inlet tube 202; and/or, the support member 332 is arranged in the air inlet tube 202, that is, the support member 332 is arranged in the extension section 204 and/or the bent section 206 and connected to the air inlet tube 202 in an extension direction of the air inlet tube 202. In the application, the support member 332 is arranged in the bent section 206 of the air inlet tube 202. The support member 332 has a support function to prevent the air inlet tube 202 from bending or collapsing and also has good gas permeability. By adopting the support member 332, an airflow can be transported smoothly in the air inlet tube 202, and the air inlet tube 202 is prevented from being blocked. The support member 332 may be, but not limited to, an elastic member such as a spring, a torsion spring and an clastic plate/sheet, or other member, made of soft material and having a support effect, such as a silicone piece, a silicone pad, a bent silicone strip, a spiral silicone member, a rubber piece, a rubber pad, a bent rubber strip, a spiral rubber member or other flexible materials, and.

Illustratively, the support 500 defines an opening 540. The extension section 204 is arranged in an axial direction of the support 500, the bent section 206 of the air inlet tube 202 is bent and arranged in the opening 540, one end of the extension section 204 is communicated with the outside, the other end of the extension section 204 is connected to one end of the bent section 206, and the other end of the bent section 206 is communicated with the airflow input port 320. The opening 540 is arranged adjacent to one end surface of the support 500, and a distance between the opening 540 and one end of the extension section 204 is greater than a distance between the end surface, adjacent to the opening 540, of the support 500 and one end of the extension section 204.

In the application, the extension section 204 is parallel to the axial direction of the support 500. The bent section 206 is bent and extend into the opening 540 via the inlet of the opening 540, and the other end of the bent section 206 penetrates through the opening 540 and extends out from an outlet of the opening 540 to be connected to the airflow generating device 300. By means of the opening 540 of the support 500, a sufficient space is reserved on the end surface of the support 500 to facilitate airflow transportation in the air inlet tube 202, and the possibility that an airflow cannot be transported due to a collapse of the air inlet tube 202 is reduced while the case of connection between the air inlet tube 202 and the airflow generating device 300 is ensured and the overall spatial arrangement of the device is taken into account. In an optimized embodiment, in the opening 540, the bent section 206 is not in contact with the support 500, and the bent section 206 only contacts the boundary of the opening 540 and does not contact other parts of the support 500.

In other embodiments, the extension section 204 extends in the axial direction of the support 500, and the other end of the extension section 206 extends through the opening 540 to be connected to a circumferential surface of the support 500. In yet another embodiment, the extension section 204 extends around the circumferential surface of the support 500, and the other end of the bent section 206 extends through the opening 540 to be connected to the circumferential surface of the support 500 or connected to one end surface of the support 500.

In an illustrative embodiment, the support 500 and the housing 210 are engaged and connected by means of a second fastener 550. In one embodiment, the bottom of the second fastener 550 is connected to the support 500, and a fastening portion of the second fastener 550 is fastened and connected to the housing 210. In another embodiment, the bottom of the second fastener 550 is connected to the housing 210, and the fastening portion of the second fastener 550 is fastened and connected to the support 500. In this embodiment, the support 500 and the housing 210 may be connected more stably by means of the second fastener 550.

In an illustrative embodiment, the oral cleaning device 10 further includes a positioning block 560. A sliding groove matched with the positioning block 560 for positioning is formed in one of the support 500 and the housing 210, and the positioning block 560 is arranged on the other one of the support 500 and the housing 210. In one embodiment, the sliding groove is formed in the support 500, and the positioning block 560 is arranged on the housing 210. In one embodiment, the sliding groove is formed in the housing 210, and the positioning block 560 is arranged on the support 500. In this embodiment, the case of connection between the support 500 and the housing 210 is improved by means of the positioning block 560 and the sliding groove which are matched with each other for positioning, thus facilitating the connection between the support 500 and the housing 210.

In an illustrative embodiment, the protection structure 330 includes a first latch 334. The first latch 334 is arranged on the housing 210, and the air inlet tube 202 is detachably connected to the first latch 334, such that the air inlet tube 202 and the housing 210 are fixed relative to each other. Specifically, the extension section 204 of the air inlet tube 202 is clamped by the first latch 334, which prevents the extension direction 204 from bending, and the extension section 204 may be folded onto a side edge of the support 500 in the axial direction of the support 500, thus facilitating the overall spatial arrangement of the device.

In an illustrative embodiment, when the first latch 334 is clamped/on the extension section 204 of the air inlet tube 202, the height of the side surface of the extension section 204 in a diameter direction of the housing 210 is less than the height of the end surface of the positioning block 560 and/or the height of the end surface of the second fastener 550, and the height of the end surface (the top surface as shown in FIG. 26) of the first latch 334 is less than the height of the end surface of the positioning block 560 and/or the height of the end surface of the second fastener 550. In the application, after the air inlet tube 202 is clamped by the first latch 334, the height of the side surface of the extension section 204 is less than the height of the end surface of the second fastener 550 and/or the height of the end surface of the positioning block 560, and the height of the end surface of the first latch 334 is less than the height of the end surface of the positioning block 560 and/or the height of the end surface of the second fastener 550, such that the air inlet tube 202, when arranged in the housing 210, merely contacts the inner surface of the housing 210 or is not in contact with the inner surface of the housing 210 during air transportation, and the air inlet tube 202 will not be squeezed by the inner wall of the housing 210 in the air transportation process, that is, the air inlet tube 202 will not collapse, thus ensuring the original air transportation space of the air inlet tube 202 and smooth air transportation in the air inlet tube 202.

Referring to FIG. 28, the oral cleaning device 10 further includes a basis 570, the basis 570 is connected to the support 500, the air inlet tube 202 is connected to the basis 570, the cover 830 is provided with an air inlet port 834, the air inlet port 834 is hollow and columnar, and the basis 570 is connected to the cover 830 by means of the air inlet port 834. An air supply channel communicated with the outside is formed by the air inlet port 834 and the air inlet tube 202. Specifically, the air supply channel is formed by the first air intake 810, the air inlet port 834 and the air inlet tube 202. The air inlet port 834 is sleeved with a rubber plug, such that the air inlet port 834 is connected to the basis 570 in a sealed manner. The basis 570 is provided with an air supply port 572, and the air supply port 572 is hollow and columnar. When the cover 830 and the air inlet tube 202 are assembled together, the air supply port 572 faces and is aligned with the air inlet port 834, the air inlet tube 202 faces and is aligned with the air supply port 572, the air inlet tube 202 is disposed around the air supply port 572, and the air inlet port 834, the air inlet tube 202 and the air supply port 572 are arranged coaxially. In the present application, the air inlet port 834 facilitates the airtight connection between the basis 570 and the cover 830.

Referring to FIGS. 29-35, an oral cleaning device 10 according to a fourth embodiment of the present application is different from the oral cleaning device 10 in the above embodiments in that, in this embodiment, the oral cleaning device 10 may include, for example, a cleaning device body 1000 and a suspension device 900.

Specifically, the suspension device 900 may be arranged, for example, on a wall. The suspension device 900 may include, for example, a suspension fixing member 910 and a charging assembly 920. The charging assembly 920 may be arranged, for example, in the suspension fixing member 910. The cleaning device body 1000 is detachably arranged on the suspension fixing member 910, such that the oral cleaning device 10 is suspended on the wall. The cleaning device body 1000, after being placed on the suspension fixing member 910, may be, for example, electrically connected to the charging assembly 920 to be charged. Further, a first positioning structure, for example, may be arranged on the suspension fixing member 910, and a second positioning structure corresponding to the first positioning structure is arranged on the cleaning device body 1000.

The cleaning device body 1000 is arranged on the suspension device 900 and electrically connected to the charging assembly 920, such that users may suspend the cleaning device body 1000 on the wall by placing the cleaning device body 1000 on the suspension device 900, and the suspension device body 1000 may be charged. In this way, the cleaning device body 1000, when placed or charged, does not occupy the plane space; and the cleaning device body 1000 is unlikely to be collided by an external force, thus being placed more stably. In addition, by means of the first positioning structure and the second positioning structure, the cleaning device body 1000 may be easily placed on the suspension device 900, and the accuracy of the placement position and the placement efficiency are improved.

Referring to FIGS. 31-35, the first positioning structure may be, for example, a first magnetic member 930, the second positioning structure may be, for example, a second magnetic member 940, and the first magnetic member 930 and the second magnetic member 940 are magnetically attractable to each other. For example, the suspension fixing member 910 comprises a first mounting side 912, and the cleaning device body 1000 comprises a second mounting side 1010 corresponding to the first mounting side 912. That is, when the cleaning device body 1000 is placed on the suspension fixing member 910, a side, close to the cleaning device body 1000, of the suspension fixing member 910 is the first mounting side 912, and a side, close to the suspension fixing member 910, of the cleaning device body 1000 is the second mounting side 1010. To be specific, a first mounting portion 914, for example, may be arranged in the suspension fixing member 910, the first mounting portion 914 is arranged close to the cleaning device body 1000, that is, the first mounting portion 914 is arranged close to the first mounting side 912, the first magnetic member 930 is arranged on the first mounting portion 914. The first mounting portion 914 may be, for example, a groove, and the first magnetic member 930 may be arranged, for example, in the groove. The cleaning device body 1000 may include, for example, a housing 210, a second mounting portion 212 is arranged in the housing 210, the second mounting portion 212 is arranged close to the suspension fixing member 910, that is, the second mounting portion 212 is arranged close to the second mounting side 1010, the second magnetic member 940 is arranged on the second mounting portion 212, the second mounting portion 212 may be, for example, a groove, and the second magnetic member 940 may be arranged, for example, in the groove. By means of the first magnetic member 930 and the second magnetic member 940, the cleaning device body 1000 may be placed on the suspension device 900 more accurately and efficiently.

In some specific implementations of this embodiment, the first positioning structure may be arranged, for example, on the side, close to the cleaning device body 1000, of the suspension fixing member 910, that is, the first positioning structure is arranged on the first mounting side 912 of the suspension fixing member 910; and the second positioning structure may be arranged, for example, on the side, close to the suspension fixing member 910, of the cleaning device body 1000, that is, the second positioning structure is arranged on the second mounting side 1010 of the cleaning device body 1000. When the cleaning device body 1000 is placed on the suspension fixing member 910, the first positioning structure and the second positioning structure are in snap fit with each other. For example, the first positioning structure may be, for example, a positioning groove, the second positioning structure may be, for example, a positioning protrusion, the positioning protrusion is arranged corresponding to the positioning groove, and when the cleaning device body 1000 is placed on the suspension fixing member 910, the second positioning structure is received in the first positioning structure. Alternatively, the first positioning structure is a positioning protrusion, the second positioning structure is a positioning groove, the positioning protrusion is arranged corresponding to the positioning groove, and when the cleaning device body 1000 is placed on the suspension fixing member 910, the first positioning structure is received in the second positioning structure.

The suspension fixing member 910 may be provided with, for example, a suspension portion, and the cleaning device body 1000 is provided with a matching portion 1020 matched with the suspension portion. When the cleaning device body 1000 is located on the suspension fixing member 910, the matching portion 1020 is attached to the suspension portion. The cleaning device body 1000 may include, for example, a handle 200. The matching portion 1020 is located at one end of the handle 200, and the handle 200 further comprises a grip portion 220. For example, the cleaning device body 1000 may be, for example, an electric toothbrush. The cleaning device body 1000 may include, for example, a brush head 100 and the handle 200. The matching portion 1020 is arranged on an end, close to the brush head 100, of the handle 200. The grip portion 220 endows the cleaning device body 1000 with certain grip region, such that the cleaning device body 1000 may be take and placed easily.

Specifically, the matching portion 1020 may be, for example, a protrusion arranged on the cleaning device body 1000, and to be specific, the matching portion 1020 may be, for example, a cylindrical protrusion. The suspension portion may include, for example, two suspension pieces 950, the two suspension pieces 950 are oppositely arranged on the suspension fixing member 910, and a suspension space 952 is formed between the two suspension pieces 950 and the suspension fixing member 910. A first space 954 is formed between the two suspension pieces 950. The first space 954 may be located, for example, on a lower portion, close to the grip portion 220, of the suspension fixing member 910. When the cleaning device body 1000 is located on the suspension fixing member 910, the grip portion 220 extends through the first space 954, and the matching portion 1020 is clamped in the suspension space 952. Further, limiting portions 956, for example, may be formed on the two suspension pieces 950. The limiting portions 956 may be located, for example, on a lower side of the suspension fixing member 910, and parts of the matching portion 102 (i.e., a side, close to the grip portion 220, of the matching portion 1020) abut against the corresponding limiting portions 956. In this way, the cleaning device body 1000 may be placed more stably.

In one specific implementation of this embodiment, when the cleaning device body 1000 is located on the suspension fixing member 910, a movement clearance is formed between the matching portion 1020 and an inner wall of the suspension space 952. Further, a suspension opening 958 is formed in a side, away from the suspension fixing member 910, of the suspension space 952. The cleaning device body 1000 can be horizontally placed on the suspension fixing member 910 via the suspension opening 958. The matching portion 1020 protrudes laterally out with respect to the grip portion 220, such that the matching portion 1020 is suspended in the first space 954, and the grip portion 220 can extend through the first space 954. A second space 955 is formed between the two suspension pieces 950, the first space 954 is opposite to the second space 955, and the grip portion 220 may extend through the second space 955. Further, the width of an opening of the first space 954 is less than the width of an opening of the second space 955. By means of the movement clearance between the matching portion 1020 and the inner wall of the suspension space 952, the matching portion 1020 may move in the suspension space 952 to allow the cleaning device body 1000 to be taken and placed easily. In addition, the width of the opening of the first space 954 is less than the width of the opening of the second space 955, such that the cleaning device body 1000 may be taken out and placed in easily and may be placed more stably. Moreover, by means of the first positioning structure cooperating with the second positioning structure, the cleaning device body 1000 may be positioned on the suspension device 900 when being charged, the placement efficiency is improved, and users may take and charge the cleaning device body 1000 more easily.

In one specific implementation of this embodiment, non-slip pads are arranged on the surfaces of sides, where the first space 954 is formed, of the two suspension pieces 950. The non-slip pads may be, for example, silicone pads. When the cleaning device body 1000 is located on the suspension fixing member 910, the non-slip pads are in contact with the cleaning device body 1000, and to be specific, the non-slip pads are in contact with the surface of the matching portion 1020. The non-slip pads may protect the surface of the matching portion 1020 and prevent damage to the surface of the matching portion 1020 caused by collisions or scratches between the matching portion 1020 and the two suspension pieces 950.

A receiving end coil 1030, for example, may be arranged in the cleaning device body 1000, and to be specific, the receiving end coil 1030 is arranged in the matching portion 1020 of the cleaning device body 1000. The charging assembly 920 may include, for example, a transmitting end coil 922. The transmitting end coil 922 may be arranged, for example, in the suspension fixing member 910. Power is supplied to the cleaning device body 1000 by means of electromagnetic induction between the receiving end coil 1030 and the transmitting end coil 922. The charging assembly 920 may further include, for example, a charging interface 924. The charging interface 924 may be, for example, connected to an external power cable and is connected to an external power supply by means of the external power cable. The charging assembly 920 may further include, for example, a conductive wire. One end of the conductive wire is connected to a circuit board in the suspension fixing member 910, and the other end of the conductive wire may be directly connected to the external power supply. The suspension fixing member 910 may further include, for example, a support case 916 and a charging circuit board 918. The charging circuit board 918, the charging interface 924 and the transmitting end coil 922 are arranged in the support case 916. The charging circuit board 918, the charging interface 924 and the transmitting end coil 922 are electrically connected. A through hole corresponding to the charging interface 924, for example, may be formed in the support case 916. The charging interface 924 is connected to the external power supply to supply power to the cleaning device body 1000 by means of electromagnetic induction between the receiving end coil 1030 and the transmitting end coil 922.

Further, a first auxiliary connecting structure is arranged on the suspension fixing member 910, a second auxiliary connecting structure is arranged on the cleaning device body 1000, and when the cleaning device body 1000 is located on the suspension fixing member 910, the first auxiliary connecting structure and the second auxiliary connecting structure are connected. The first auxiliary connecting structure and the second auxiliary connecting structure may be, for example, magnetic members, fasteners, or the like. By means of the connection between the first auxiliary connecting structure and the second auxiliary connecting structure, the connection stability of the cleaning device body 1000 and the suspension fixing member 910 may be further improved.

Referring to FIGS. 31 and 32 again, the suspension device 900 may further include, for example, a suspension mounting member 970. The suspension fixing member 910 comprises a fixing member 960, one side of the suspension mounting member 970 is detachably connected to the fixing member 960, and the other side of the suspension mounting member 970 is connected to a wall. The suspension mounting member 970 may be fixed to the wall, for example, by bonding, screws or the like. A mounting protrusion, for example, may be arranged on a side, close to the fixing member 960, of the suspension mounting member 970, and a mounting groove, for example, may be formed in the fixing member 960, and the mounting protrusion may be mounted, for example, in the mounting groove. Of course, the fixing member 960 and the suspension mounting member 970 may be detachably connected, for example, by magnetic attraction or fasteners, which are not enumerated in this embodiment.

Referring to FIGS. 36-39, a fifth embodiment of the present application provides a suspension device 900, which is different from the suspension device 900 in the above embodiment in that, in this embodiment, the suspension mounting member 970 may be, for example, a metal part, a plastic part or the like, a fixing portion 972 is arranged on one side of the suspension mounting member 970, and the other side of the suspension mounting member 970 is attached to a wall. Referring to FIG. 37, the fixing portion 972 may include, for example, a main fixing portion 974 and a first hooking portion 976 arranged on the main fixing portion 974. The first hooking portion 976 may be arranged, for example, around the periphery of the main fixing portion 974, and the edge of a side, away from the main fixing portion 974, of the first hooking portion 976 is arranged along a circumferential trajectory. The main fixing portion 974 may be, for example, a circular structure or may be, for example, a triangular structure, and this embodiment has no limitation in this aspect. Referring to FIG. 39, the suspension fixing member 910 may be, for example, a metal part, a plastic part or the like. A second hooking portion 911 is arranged on a side, close to the suspension mounting member 970, of the suspension fixing member 910, and the second hooking portion 911 is matched with the first hooking portion 976. The second hooking portion 911 may be hooked on the first hooking portion 976.

In this embodiment, the suspension mounting member 970 of the suspension device 900 comprises the fixing portion 972 arranged on one side thereof. The fixing portion 972 includes the main fixing portion 974 and the first hooking portion 976 arranged around the periphery of the main fixing portion 974, and the edge of the side, away from the main fixing portion 974, of the first hooking portion 976 is arranged along the circumferential trajectory; and the suspension fixing member 910 comprises the second hooking portion 911, and the second hooking portion 911 is matched with the first hooking portion 976. Since the edge of the side, away from the main fixing portion 974, of the first hooking portion 976 is arranged along the circumferential trajectory, the suspension mounting member 970 may be mounted on the wall at any angle, and the second hooking portion 911 on the suspension fixing member 910 may be hooked on the first hooking portion 976. In this way, when the suspension device 900 is used, the suspension mounting member 970 may be mounted freely to make operation convenient, and the suspension fixing member 910 may be suspended stably in a proper direction.

Specifically, the suspension mounting member 970 may further include, for example, a mounting portion 978, and the mounting portion 978 is mounted on the wall. A side, close to the wall, of the mounting portion 978 may be provided with, for example, an adhesive, and the mounting portion 978 is attached to the wall with the adhesive. The mounting portion 978 may also be fixed to the wall, for example, by rivets, screws or the like. This embodiment has no limitation in this aspect. The fixing portion 972 protrudes out of the mounting portion 978, that is, the fixing portion 972 protrudes out in a direction away from the mounting portion 978. A side, close to the suspension mounting member 970, of the suspension fixing member 910 may be provided with, for example, a receiving opening 913, and the second hooking portion 911 is arranged on a side wall of the receiving opening 913. When the suspension fixing member 910 is hooked on the suspension mounting member 970, the fixing portion 972 is located in the receiving opening 913, and the second hooking portion 911 is hooked on the first hooking portion 976. When the suspension fixing member 910 is assembled on the suspension mounting member 970, the suspension fixing member 910 is pulled downwards under the action of gravity to allow the fixing portion 972 to enter the second hooking portion 911, such that the fixing effect is further improved.

In one specific implementation of this embodiment, one of the second hooking portion 911 and the first hooking portion 976 is an opening, and the other one of the second hooking portion 911 and the first hooking portion 976 is a protrusion. The shape and size of the receiving opening 913 may, for example, match the shape and size of the fixing portion 972. In some implementations, the shape and size of the cross section of the receiving opening 913 may be, for example, identical with the shape and size of the cross section of the fixing portion 972, and the fixing portion 972 is tightly arranged in the receiving groove 913, such that hooking is more stable, and shaking is unlikely to occur. In some other implementations, the shape of the receiving opening 913 may be, for example, different from the shape of the fixing portion 972, the receiving opening 913 may be, for example, rectangular, trapezoidal or the like, the size of the receiving opening 913 may be, for example, greater than the size of the fixing portion 972, and the fixing portion 972 is received in the receiving opening 913.

Referring to FIG. 37, in this embodiment, the first hooking portion 976 is a circular structure arranged around the periphery of the main fixing portion 974. Since the first hooking portion 976 is a circular structure arranged around the periphery of the main fixing portion 974, the suspension mounting member 970 may be mounted on the wall at any angle, and the second hooking portion 911 on the suspension fixing member 910 may be hooked on the first hooking portion 976.

Referring to FIGS. 38A and 38B, in this embodiment, a plurality of first hooking portions 976 are arranged on the main fixing portion 974, and the plurality of first hooking portions 976 are distributed at intervals along the periphery of the main fixing portion 111. Further, the plurality of first hooking portions 976 may be, for example, identical in structure, and the intervals between the adjacent plurality of first hooking portions 976 are identical, that is, sides, away from the main fixing portion 974, of the plurality of first hooking portions 976 are distributed in circumferential symmetry. Since the plurality of first hooking portions 976 are arranged around the periphery of the main fixing portion 974, the suspension mounting member 970 may be mounted on the wall at any angle, and the second hooking portion 911 on the suspension fixing member 910 may be hooked on the first hooking portions 976.

Further, the length of the second hooking portion 911 in a circumferential direction of the receiving opening 913 is greater than the length of the interval formed between any two adjacent first hooking portions 976 on the circumferential direction. Here, the length of the second hooking portion 911 refers to the side length of the second hooking portion 911 (i.e., the length of an arc), the length of the interval between every two adjacent two first hooking portions 976 may also be, for example, the length of an arc. The length of the second hooking portion 911 in the circumferential direction of the receiving opening 913 is, for example, greater than the length of each interval on the circumferential trajectory, that is, the length of the second hooking portion 911 is, for example, greater than the length of the maximum interval. In this way, when the interval between two first hooking portions 976 faces upwards, the second hooking portion 911 may be hooked on the two first hooking portion 976 and the interval, such that the suspension mounting member 970 may be mounted on the wall at any angle, and the second hooking portion 911 on the suspension fixing member may be hooked on the first hooking portion 976. Further, the length of the second hooking portion 911 in the circumferential direction of the receiving opening 913 is greater than the length of the first hooking portions 976 on the circumferential trajectory, for example, the length of the second hooking portion 911 in the circumferential direction of the receiving opening 913 is greater than the length of each first hooking portion 976 on the circumferential trajectory, that is, the length of the second hooking portion 911 is greater than the maximum length of the first hooking portions 976. In this way, when any one of the first hooking portions 976 faces upwards, the second hooking portion 911 may be hooked on the first hooking portions 976, such that the suspension mounting member 970 may be mounted on the wall at any angle, and the second hooking portion 911 on the suspension fixing member 910 may be hooked on the first hooking portions 976.

Referring to FIGS. 40 and 41, a disengagement abutting portion 915, for example, may be arranged on the side wall of the receiving opening 913, and the disengagement abutting portion 915 is arranged opposite to the second hooking portion 911. When the first hooking portion 976 abuts against the disengagement abutting portion 915, the second hooking portion 911 is disengaged from the first hooking portion 976. In this embodiment, the receiving opening 913 of the suspension fixing member 910 may be, for example, a circular structure, and the outer diameter of the fixing portion 972 may be, for example, equal to the diameter of the receiving opening 913. Of course, this embodiment is not limited to such an arrangement. When the suspension fixing member 910 needs to be disengaged from the suspension mounting member 970, users may, for example, pull the suspension fixing member 910 upwards to enable the first hooking portion 976 of the fixing portion 972 to abut against the disengagement abutting portion 915, at this moment, the first hooking portion 976 is disengagement from the second hooking portion 911, and the suspension fixing member 910 may be taken out easily. Further, the length of the second hooking portion 911 in the circumferential direction is less than or equal to half of the perimeter of the receiving opening 913. In this way, when the suspension fixing member 910 is pulled upwards, the fixing portion 972 abuts against the disengagement abutting portion 915 to be disengaged from the second hooking portion 911, and the suspension fixing member 910 may be taken away from the suspension mounting member 970 more easily.

Referring to FIGS. 42-44, a sixth embodiment of the present application provides a suspension device 900, which is different from the suspension device 900 in the above embodiments in that, in this embodiment, the suspension device 900 further includes a suspension magnetic member 932.

The suspension fixing member 910 may comprise, for example, a wall-mounted side 917 and a charging side 919 opposite to the wall-mounted side 917. The wall-mounted side 917 is configured to be fixed to a wall, a desk, a dressing table, or the like. The charging side 919 is connected to a device to be charged, such as the oral cleaning device 10. The first magnetic member 930, the transmitting end coil 922 and the suspension magnetic member 932 are all arranged on the suspension fixing member 910. The first magnetic member 930 and the transmitting end coil 922 are arranged close to the charging side 919 of the suspension fixing member 910, and the suspension magnetic member 932 is arranged close to the wall-mounted side 917 of the suspension fixing member 910. The first magnetic member 930 and the transmitting end coil 922 are arranged corresponding to each other to realize wireless charging after being magnetically connected to the device to be charged. The suspension magnetic member 932 and the transmitting end coil 922 are staggered in a first direction to reduce the influence of the suspension magnetic member 932 on the transmitting end coil 922. In this way, the suspension device 900 may be mounted on the wall by means of the suspension magnetic member 932, and when the transmitting end coil 922 charges the device to be charged, heat generation may be reduced, and the charging efficiency may be improved.

In some implementations of this embodiment, the transmitting end coil 922 and the first magnetic member 930 may be arranged, for example, on an outer surface of the suspension fixing member 910, that is, the transmitting end coil 922 and the first magnetic member 930 are arranged on a side, away from the wall-mounted side 917, of the charging side 919 of the suspension fixing member 910, and the transmitting end coil 922 and the first magnetic member 930 may be connected to the outer surface of the suspension fixing member 910, for example, by bonding, riveting or the like. The suspension magnetic member 932 may be arranged, for example, on the outer surface of the suspension fixing member 910. To be specific, the suspension magnetic member 932 may be arranged, for example, on a side, away from the charging side 919, of the wall-mounted side 917 of the suspension fixing member 910, and the suspension magnetic member 932 may be connected to the outer surface of the suspension fixing member 910 for example, by bonding, riveting, or the like. In some other implementations of this embodiment, the transmitting end coil 922, the suspension magnetic member 932 and the first magnetic member 930 may be arranged, for example, in the suspension fixing member 910. Of course, the specific positions of the transmitting end coil 922, the suspension magnetic member 932 and the first magnetic member 930 in the suspension fixing member 910 may be set as actually needed, and this embodiment has no limitation in this aspect.

In one implementation of this embodiment, the suspension magnetic member 932 has a first projection on the suspension fixing member 910 in the first direction, the transmitting end coil 922 has a second projection on the suspension fixing member 910 in the first direction, and the first projection may be located, for example, outside the second projection, or the second projection is located outside the first projection. In this way, the suspension magnetic member 932 and the transmitting end coil 922 are staggered in the first direction, and the influence of the suspension magnetic member 932 on the transmitting end coil 922 is reduced.

Further, the first magnetic member 930 and the suspension magnetic member 932 are at least partially overlapped in the first direction to reduce the influence of the first magnetic member 930 and the suspension magnetic member 932 on the transmitting end coil 922. The first magnetic member 930 and the suspension magnetic member 932 may be magnets, or components capable of be attracted by magnets such as iron sheets. Specifically, in one implementation of this embodiment, the first magnetic member 930 may be, for example, a round magnet and is arranged in the middle, the transmitting end coil 922 is arranged around the first magnetic member 930. The transmitting end coil 922 may be, for example, a ring structure, and the first magnetic member 930 is located at an inner space surrounded by the ring structure. The suspension magnetic member 932 may be, for example, a magnet and is arranged corresponding to the first magnet 930. The suspension magnetic member 932 may also be, for example, a round magnet, and the suspension magnetic member 932 and the first magnetic member 930 are identical in shape and size and correspond to each other in the first direction. The suspension magnetic member 932 and the first magnetic member 930 are identical in shape and size and correspond to each other in the first direction, such that the influence of the suspension magnetic member 932 on the coil may be further reduced. Of course, the diameter of the suspension magnetic member 932 may be, for example, greater than the diameter of the first magnetic member 930; or, the thickness of the suspension magnetic member 932 in the first direction may be, for example, greater than the thickness of the first magnetic member 930. This embodiment has no limitation in this aspect. In this way, the magnetic intensity of the suspension magnetic member 932 may be improved to thereby improve the suspension stability. In another implementation of this embodiment, the suspension magnetic members 932 and the first magnetic members 930 may be formed, for example, by a plurality of magnets, which are configured and arranged as a ring structure, and sides, facing the charging side 919, of every two adjacent magnets are opposite in magnetic polarity. Further, positioning iron sheets may be arranged on sides, facing the wall-mounted side 917, of the plurality of magnets, such that the plurality of magnets may easily configured as the ring structure.

In another implementation of this embodiment, the first magnetic member 930 may be, for example, a ring magnet or a ring structure formed by a plurality of magnets, and the transmitting end coil 922 is located on an inner ring of the ring structure of the first magnetic member 930, that is, the first magnetic member 930 is arranged around the transmitting end coil 922. The suspension magnetic member 932 may be, for example, a magnet and is arranged corresponding to the first magnetic member 930. The suspension magnetic member 932 may be, for example, a ring magnet or a ring structure formed by a plurality of magnets. The suspension magnetic member 932 and the first magnetic member 930 are identical in shape and size and correspond to each other in the first direction. Of course, the diameter of the suspension magnetic member 932 may be, for example, greater than the diameter of the first magnetic member 930, and the thickness of the suspension magnetic member 932 in the first direction may be, for example, greater than the thickness of the first magnetic member 930. This embodiment has no limitation in this aspect.

In one implementation of this embodiment, the first magnetic member 930 has a second projection on the suspension fixing member 910 in the first direction, and the first projection may, for example, cover the second projection. The suspension magnetic member 932 and the first magnetic member 930 may be, for example, identical in shape and correspond to each other in the first direction, such that the influence of the suspension magnetic member 932 on the coil may be further reduced. To be specific, the diameter of the suspension magnetic member 932 may be, for example, greater than the diameter of the first magnetic member 930, such that the magnetic intensity of the suspension magnetic member 932 may be improved, and the thickness of the suspension magnetic member 932 is not increased, thus saving the internal space of the suspension fixing member 910, improving the suspension stability and reducing the size of the suspension fixing member 910.

Referring to FIGS. 43 and 44 again, the suspension device 900 may further include, for example, a magnetic shield structure. The magnetic shield structure is arranged between the transmitting end coil 922 and the suspension magnetic member 932. To be specific, the magnetic shield structure may be, for example, a first magnetic shield member 980; or, the magnetic shield structure is a nanocrystal magnetic shield piece 990; or, the magnetic shield structure may include, for example, the first magnetic shield member 980 and the nanocrystal magnetic shield piece 990, and the first magnetic shield member 980 and the nanocrystal magnetic shield piece 990 are stacked together. The first magnetic shield member 980 may be a hard magnetic shield member, such as a ferrite magnetic shield member formed by high-temperature sintering. By arranging the magnetic shield structure between the transmitting end coil 922 and the suspension magnetic member 932, the influence of the suspension magnetic member 932 on the transmitting end coil 922 may be further reduced to thereby improve the charging efficiency. By adopting the nanocrystal magnetic shield piece 990, the magnetic shield structure may be thin while the magnetic shield effect is guaranteed, the internal space of the suspension fixing member 910 may be saved while the magnetic shield effect is improved, and the size of the suspension fixing member 910 is further reduced.

Referring to FIG. 45, the cleaning device body 1000 is provided with a receiving end coil 1030. The receiving end coil 1030 and the transmitting end coil 922 are connected by electromagnetic induction to realize wireless charging. The cleaning device body 1000 may be further provided with, for example, a second magnetic member 940, a circuit board 600 and a second magnetic shield member 1040. The receiving end coil 1030, the second magnetic member 940 and the second magnetic shield member 1040 may be arranged, for example, on an outer surface, close to the suspension device 900, of the cleaning device body 1000 or may be arranged, for example, on a side, close to the suspension device 900, of the cleaning device body 1000. The second magnetic member 940 corresponds to the first magnetic member 930 in structure. The receiving end coil 1030 corresponds to the transmitting end coil 922 in structure. The circuit board 600 is electrically connected to the receiving end coil 1030. The second magnetic shield member 1040 may be arranged, for example, on a side, away from the transmitting end coil 922, of the receiving end coil 1030. To be specific, the second magnetic shield member 1040 may be arranged, for example, between the circuit board 600 and the second magnetic member 940, such that the interference of the circuit board 600 on the receiving end coil 1030 is avoided, and the charging efficiency will not be affected. The second magnetic shield member 1040 may be, for example, a nanocrystal magnetic shield piece, such that the internal space of the cleaning device body 1000 is saved while the magnetic shield effect is improved.

Referring to FIGS. 46-49, a seventh embodiment of the application provides a suspension device 900, which is different from the suspension device 900 in the above embodiments in that, in this embodiment, the suspension device 900 may include, for example, a cleaning device body 1000, a display 2000 and a switch 3000.

The display 2000 may be arranged, for example, on the cleaning device body 1000. The switch 3000 is arranged in the cleaning device body 1000, and the switch 3000 is located on a side, away from the surface of the cleaning device body 1000, of the display 2000. The display 2000 is arranged on a handle 200 and connected to a housing 210. The display 2000 may be, for example, a liquid crystal display (LCD) or other displays. The display 2000 is configured to display the operating mode, the quantity of electricity, and/or other information of the oral cleaning device 10. The switch 300 is arranged in the housing 210 and located on the side, away from the surface of the housing 210, of the display 2000.

The display 2000 is arranged on the cleaning device body 1000 of the oral cleaning device 10, and the switch 3000 is arranged inside the cleaning device body 1000 and located on the side, away from the surface of the housing 210, of the display 2000. By arranging the switch 3000 inside the housing 210, the switch is hidden. When the display 2000 is pressed, the switch 3000 will be turn on or off under pressure. In this way, water is prevented from entering the housing 210 while button control and on-screen display are realized, thus further reducing the possibility that water enters the housing 210. The space of the surface of the housing 210 may be saved, and the structure is simple. In addition, the switch 3000 will not be mistouched when water is splashed onto the display in use, thus improving the user experience.

Further, the switch 3000 may be, for example, a pressure switch, and the pressure switch is arranged corresponding to the display 2000 and electrically connected to the display 2000. The display 2000, when pressed, will deform to generate, for example, a signal and transmit the signal to the pressure switch, and the pressure switch controls the oral cleaning device 10 to be turned on or off and switch the operating mode of the oral cleaning device 10 according to a relative pressure received by the display 2000. A gap, for example, may be formed between the display 2000 and the pressure switch. When pressed, the display 2000 moves close to the surface of the pressure switch and comes into contact with the pressure switch to thereby trigger the pressure switch to control the oral cleaning device 10 to operate. For another example, the surface, close to the pressure switch, of the display 2000 comes into contact with the surface, close to the display 2000, of the pressure switch, and when the display 2000 is pressed, the pressure switch is squeezed to be triggered to control the oral cleaning device 10 to operate.

Referring to FIG. 47 again, the surface of the cleaning device body 1000 is provided with a water stop structure 1050, and the water stop structure 1050 is arranged around the display 2000. The water stop structure 1050 may be, for example, a protrusion arranged around the display 2000, and the protrusion protrudes out of the surface of the cleaning device body 1000. To be specific, the water stop structure 1050 is arranged at an end, close to a brush head 100, of the handle 200. The water stop structure 1050 may prevent water from entering the cleaning device body 1000, and particularly, in a case where water flows towards the handle 200 from the brush head 100 when the oral cleaning device 10 is used by users, the water stop structure 1050 may guide the water to flow to the side edges of the handle 200 rather than flow to the display 2000. In addition, by arranging the water stop structure 1050 at the end, close to the brush head 100, of the handle 200, the users will not mistouch the display 2000 when holding the handle 200 by hands.

In one specific implementation of this embodiment, the display 2000 may be arranged, for example, on the housing 210, and to be specific, a screen surface of the display 2000 may be, for example, exposed outside the housing 210, such that users may see contents displayed by the display 2000 through the housing 210. In addition, the users may press the display 2000 to control the switch 3000 by pressure so as to control the oral cleaning device 10 to be turned on or off and switch the cleaning mode of the oral cleaning device 10.

In one specific implementation of this embodiment, the display 2000 may be arranged, for example, in the housing 210, and the housing 210 is provided with a display region 230 corresponding to the display 2000. The display region 230 may be, for example, a hollowed-out region formed in the housing 210, and users may see contents displayed by the display 2000 through the hollowed-out region. Further, referring to FIGS. 48 and 49, a lens 240, for example, may be arranged in the display region 230, and the lens 240 may be made from, for example, transparent plastic or transparent glass. The display 2000 may be protected by the lens 240. Specifically, the housing 210 comprises, for example, a lens mounting portion 250 arranged around the display region 230, and the lens 240 is mounted on the lens mounting portion 250. The lens mounting portion 250 may be, for example, a recess formed in the housing 210. The lens 240 may be mounted on the lens mounting portion 250, for example, by means of a lens fixing member 260. The lens fixing member 260 may be, for example, an adhesive piece, and the lens 240 is bonded on the lens mounting portion 250 by means of the adhesive piece. Of course, the lens fixing member 260 may also be, for example, a magnetic member, a rivet, or the like. This embodiment has no limitation in this aspect. By mounting the lens 240 in the space formed in the lens mounting portion 250, the transition between the surface of the lens 240 and the surface of the housing 210 are smoother, such that the hand feeling of users is improved, thus further improving the user experience. The oral cleaning device 10 may further include, for example, a decorative part 270, and the decorative part 270 may be arranged, for example, around the edge of the lens 240. The housing 210 may further comprises a decorative part mounting portion 280, and the decorative part 270 is arranged on the decorative part mounting portion 280. By adopting the decorative part 270, the visual effect of the oral cleaning device 10 may be improved, thus further improving the user experience.

Further, the oral cleaning device 10 may further include, for example, a display guard 1060. The display guard 1060 may be arranged, for example, around the display 2000. One side of the display guard 1060 is in contact with the switch 3000, and the display guard 1060 is hermetically/sealedly connected to the housing 210. The display guard 1060, when pressed, deforms to trigger the switch 3000. For example, when users press the lens 240 in the display region, the lens 240 may, for example, come into contact with the display guard 1060, such that the display guard 1060 is pressed to deform slightly. The slight deformation is transferred to the pressure switch to thereby trigger the pressure switch. The display guard 1060 may be, for example, a soft rubber guard, which is sealedly connected to the housing 210 directly. Of course, the display guard 1060 may also be made from other materials. The display guard 1060 is sealedly connected to the housing 210 by means of a scaling and connecting piece. This embodiment has no limitation in this aspect. The display guard 1060 may define, for example, a receiving space, the display 2000 is arranged in the receiving space, and the screen surface of the display 2000 is exposed outside the display guard 1060. The display guard 1060 may be fixed to the housing 210, for example, by rivets, screws or the like. Of course, the embodiment is not limited to such an arrangement. By means of the display guard 1060, the display 2000 may be protected, and the assembly is convenient. The display guard 1060 is sealedly connected to the housing 210, such that the display guard 1060 has a waterproof scaling effect and further prevents water from entering inside the housing 210, which may otherwise cause damage to the electronic elements installed in the housing 210.

The oral cleaning device 10 may further include, for example, a key display circuit board 1070. The key display circuit board 1070 may be arranged, for example, on a side, away from the housing 210, of the switch 3000 and is connected to the housing 210, and the switch 3000 may be, for example, electrically connected to the key display circuit board 1070. Fixing holes, for example, may be formed in the key display circuit board 1070, fixing pillars are arranged in the housing 210, and fasteners such as rivets or screws penetrate through the fixing holes to secure the key display circuit board 1070 on the fixing pillars so as to fix the key display circuit board 1070 to the housing 210, thus improving the stability of the key display circuit board 1070. Further, the oral cleaning device 10 may further include, for example, a switch support member 1080. The switch support member 1080 is arranged on a side, away from the display 2000, of the key display circuit board 1070 and is in contact with the key display circuit board 1070. When the switch 3000 is pressed, the switch support member 1080 provides support and prevents the key display circuit board 1070 from being damaged.

The oral cleaning device 10 may further include, for example, a circuit board 600. The circuit board 600 may be arranged, for example, in the housing 210. The key display circuit board 1070 and the circuit board 600 may be, for example, electrically connected, and the circuit board 600 and the switch 3000 are arranged on two opposite sides of the housing 210. The housing 210 may comprise, for example, a first side wall and a second side wall opposite to the first side wall. Of course, the housing 210 may be, for example, formed integrally. The switch 3000 is arranged close to the first side wall, and the circuit board 600 is arranged close to the second wall. For example, a support 500 is also arranged in the housing 210, and electronic elements such as a motor 400, an airflow generating device 300 and a battery 700 may be arranged, for example, to the support 500. The circuit board 600 and the switch 3000 may be arranged, for example, on two opposite sides of the support 500, that is, an annular space, for example, is formed between the support 500 and the housing 210, the annular space may have, for example, two opposite sides, the circuit board 600 is arranged in one side of the annular space, and the switch 3000 is arranged in the other side of the annular space. Of course, such an arrangement is merely illustrative. By arranging the circuit board 600 and the switch 3000 at two opposite sides of the housing 210, the circuit board 600 may be prevented from being damaged when the switch 3000 is pressed, thus further improving the safety and stability. An automatic switch is arranged on cither the key display circuit board 1070 or the circuit board 600. The automatic switch may be, for example, a gyroscope used for detecting the state of the oral cleaning device 10 to control the oral cleaning device 10 to turn off automatically.

Referring to FIGS. 50-52, an eighth embodiment of the application provides an oral cleaning device 10, which is different from the oral cleaning device 10 in the above embodiments in that, in this embodiment, the oral cleaning device 10 further includes a controller 610. The controller 610 may be arranged, for example, on the circuit board 600 and is electrically connected to the motor 400, the airflow generating device 300 and the switch 3000 by means of the circuit board 600. The switch 3000 is configured to generate an operation signal in response to a press operation and send the operation signal to the controller 610, and the controller 610 is configured to control the airflow generating device 300 and the motor 400 to work in response to the operation signal. According to the oral cleaning device 10 in this embodiment, the airflow generating device 300 and the motor 400 may be controlled to work by means of one switch 3000, such that the structure is simplified while the cleaning capacity is improved, operation steps are reduced, and the user experience is further improved.

Specifically, the display 2000 may be, for example, electrically connected to the controller 610, the switch 3000 is arranged corresponding to the display 2000, and the switch 3000 is electrically connected to the display 2000 and the controller 610. The switch 3000 may be, for example, a pressure sensor and transmits signals by pressure changes. The display 2000, when pressed, will deform to generate, for example, a signal, corresponding to a relative pressure received by the display 2000, and transmit the signal to the switch 3000, and the switch 3000 sends to the controller 610 an operation signal corresponding to the signal received by the switch 3000. A gap, for example, may be formed between the display 2000 and the switch 3000 when the display 2000 is in a natural state. When the display 2000 is pressed, the surface, close to the switch 3000, of the display 2000 comes into contact with the switch 3000 to thereby trigger the switch 3000, such that the switch 3000 generates an operation signal. Alternatively, the surface, close to the switch 3000, of the display 2000 is in contact with the surface, close to the display 2000, of the switch 3000 when the display 2000 is in the natural state, and when the display 2000 is pressed, the switch 3000 is squeezed to be triggered to generate an operation signal.

Referring to FIG. 53, the switch 3000 may, for example, receive a press operation performed by a user, generate a starting signal as an operation signal according to the press operation and send the starting signal to the controller 610, and the controller 610, when determining that the operation signal is the starting signal according to the duration of the press operation, controls the airflow generating device 300 to start and controls the motor 400 to start a first preset time later. To be specific, in a case where the duration of the press operation is within a first time range which may be, for example, 0-3 s, the press operation is a “short press”, and the controller 610 determines the operation signal as the starting signal. The first preset time may be, for example, 0.3 s. When the motor 400 and the airflow generating device 300 are started to work, the airflow generating device 300 is started first, and the motor 400 is started after the airflow generating device 300 works for 0.3 s, such that food debris and dirty water in the airflow hole 112 of the brush head 100 may be sprayed out by means of the airflow generating device 300 to realize self-cleaning of the oral cleaning device 10.

When the oral cleaning device 10 needs to be stopped, the controller 610 may, for example, receive a stop signal to control the motor 400 to stop and control the airflow generating device 300 to stop a second preset time later. The second preset time may be, for example 0.1 s. When the motor 400 and the airflow generating device 300, which are in operation, need to be stopped, the motor 400 is controlled to stop first, and the airflow generating device 300 is controlled to stop 0.1 s after the motor 400 stops. In this way, dirty water left in the airflow hole 112 of the brush head 100 may be sprayed out by means of the airflow generating device 300 to realize self-cleaning of the oral cleaning device 10.

In the operating process of the oral cleaning device 10, that is, when the airflow generating device 300 and the motor 400 are started to work, the controller 610 may, for example, control the display 2000 to display the operating mode and the quantity of electricity. Of course, the contents displayed by the display 2000 may be set as actually needed, and this embodiment has no limitation in this aspect. In the operating process of the oral cleaning device 10, the controller 610 may, for example, detect the operating time, control the motor 400 to stop when detecting that the operating time is equal to a third preset time, and control the airflow generating device 300 to stop the second preset time later. The third preset time may be, for example, 2 min. When detecting that the operating time reaches 2 min, the controller 610 controls the motor 400 and the airflow generating device 300 to stop. By setting the third preset time, the oral cleaning device 10 may stop automatically after operating for a certain time. By controlling the oral cleaning device 10 to work according to the scientific tooth brushing time, a good cleaning effect can be achieved.

In the operating process of the oral cleaning device 10, the switch 3000 may, for example, receive a first press operation and generate an operation signal. When determining, according to the operation signal, that a time interval between the first press operation and the previous press operation is within a second time range, the controller 610 controls the motor 400 to stop and controls the airflow generating device 300 to stop the second preset time later. Wherein, the second time range may be, for example, greater than 3 s, that is, when determining that the first press operation is a “short press” and the time interval between the two presses is greater than 3 s, the controller 610 determines that the operation signal is a stop signal and controls the motor 400 and the airflow generating device 300 to stop. When controlling the motor 400 and the airflow generating device 300 is controlled to stop, the controller 610 controls the display 2000 to continue to display for 3 s and then turn off automatically. Of course, this embodiment is not limited to such a setting.

Referring to FIG. 54, in a case where the duration of the press operation is within a fifth time range, the switch 3000 generates a fluid generating device on/off state switching signal in response to the press operation, and the controller 610 switches the on/off state of the airflow generating device 300 in response to the fluid generating device on/off state switching signal. The fifth time range may be, for example, greater than or equal to 5 s. In a case where the duration of the press operation is greater than or equal to 5 s, the controller 610 may, for example, determine the operation signal as the fluid generating device on/off state switching signal to thereby switch the off/off state of the airflow generating device 300.

The oral cleaning device 10 may further include, for example, a battery 700. The battery 700 is arranged in the cleaning device body 1000. The controller 610 may, for example, determine whether the battery 700 of the oral cleaning device 10 is being charged and controls the display 2000 to display a state of charge or a state of full charge. When the battery 700 starts to be charged or is being charged, the switch 3000 is short pressed, and then the controller 610 controls the display 2000 to display the state of charge for 5 s and then turn off. For another example, when the battery 700 stops from being charged, the controller 610 controls the display 2000 to display the state of charge for 5 s and then turn off. For yet another example, when the battery 700 is fully charged, is charged again after being fully charged or the switch 3000 is short pressed after the battery 700 is fully charged, the controller 610 controls the display 2000 to display the state of charge for 5 s and then turn off. Of course, this embodiment has no limitation in this aspect.

When the battery 700 is charged, the switch 3000 may, for example, receive a press operation. In a case where the duration of the press operation is within the fifth time range (which may be, for example, greater than or equal to 5 s), the oral cleaning device 10 enters a factory mode, and the controller 610 controls the motor 400 to vibrate for 0.5 s for feedback to inform users that the oral cleaning device 10 enters the factory mode. In the factory mode, self-inspection parameters, for example, may be displayed. The switch 3000 may be, for example, further pressed, the controller 610 may, for example, recognize the number of press operation within the first 3 s. In a case where one press is performed within the first 3 s, the controller 610 controls language switching, controls the motor 400 to vibrate for 0.5 s for feedback, and controls the display 2000 to display a language after switching for 7 s and then turn off. The languages may include, for example, Chinese and English. In a case two presses are performed within the first 3 s, the controller 610 may, for example, determine the operation signal as the fluid generating device on/off state switching signal to switch the off/off state of the airflow generating device 300, and the controller 610 controls the motor 400 to vibrate twice (each for 0.5 s) at an interval of 0.5 s for feedback and controls the display 2000 to display the on/off state after switching for 7 s and then turn off. Of course, the time ranges, the preset times and the display time of the display 2000 may be set as actually needed, and the values mentioned above in this embodiment are merely illustrative and are not intended to limit the application.

In one implementation of this embodiment, after the motor 400 and the airflow generating device 300 are started to work, the controller 610, when detecting that the operating time reaches a fourth preset time, may control the motor 400 and the airflow generating device 300 to pause for a fifth preset time and then to restart to work. The fourth preset time may be, for example, 30 s, and the fifth preset time may be, for example, 0.5 s. That is, in the operating process, the motor 400 and the airflow generating device 300 pause for 0.5 s every 30 s, and the motor 400 is controlled to vibrate to remind users to change the tooth brushing region and give feedback to the users, thus improving the user experience.

In one implementation of this embodiment, when the controller 610 controls the motor 400 and the airflow generating device 300 to stop, the controller 610 may, for example, recognize and save the operating mode reaching a continuous operating time range, which may be, for example, greater than 5 s, of the oral cleaning device 10 before the oral cleaning device 10 stops. That is, the operating mode reaching the continuous working time range, which is greater than 5 s, before stopping is saved, and the oral cleaning device 10 works according to this operating mode when started next time.

Referring to FIG. 55, the switch 3000 generates the operation signal in response to a second press, and in a case where the controller 610 determines, according to the operation signal, that a time interval between the second press and the previous press is within a third time range, the controller 610 switches the operating mode. The third time range may be, for example, 0-3 s. In a case where the time interval between the two presses is less than 3 s, whether the duration of the second press is less than 3 s is determined. In a case where the duration of the second press is less than 3 s, the operating mode is switched.

In one implementation of this embodiment, the operating modes may include, for example, a soft mode, a cleaning mode and a brightening mode. Wherein, the soft mode may, for example, give priority to the comfortable experience in use; and in the soft mode, the amplitude of swing, force and air flow volume are about 50% of the amplitude of swing, force and air flow volume in the cleaning mode. The battery life is not less than 60 days, parameters of the driving motor may be, for example, 130 Hz and duty cycle of 70%, and the air flow volume of the airflow generating device may be, for example, greater than or equal to 500 mL+20% (˜1.8V). The cleaning mode may, for example, give priority to the cleaning experience in use, the amplitude of swing and cleaning effect are good, the air flow volume may be, for example, 700-800 ml/min, noise is about 55 dB, and the battery life is not less than 30 days; and the parameters of the motor 400 may be, for example, 180 Hz and duty cycle of 90%, and the air flow volume of the airflow generating device may be, for example, greater than or equal to 800 mL+20% (˜2.5V). The brightening mode may, for example, give priority to a better cleaning effect; in the brightening mode, the oral cleaning device works intermittently, the amplitude of swing and air flow volume are the maximum, the parameters of the motor 400 may be, for example, 180 Hz and duty cycle of 30% and 130 Hz and 90%, which are switched alternately every 50 ms, and the air flow volume of the airflow generating device may be, for example, greater than or equal to ≥1 L±20% (≈3.2V). Of course, the operating modes mentioned here are merely illustrative and are not intended to limit this embodiment.

In a case where the motor 400 and the airflow generating device 300 do not work and the duration of the press operation is within a fourth time range, the switch 3000 generates a travel lock enabling or disabling signal in response to the press operation and sends the travel lock enabling or disabling signal to the controller 610. The controller 610, in response to the travel lock enabling or disabling signal, enables or disables a travel lock. For example, the fourth time range may be, for example, greater than 3 s; in a case where a time interval between two presses is less than 3 s and it is determined that the duration of the press is greater than 3 s, the travel lock is enabled or disabled. In a case where the travel lock is disabled, the controller 610 enables the travel lock in response to the second press operation. In a case where the travel lock is enabled, the controller 610 disables the travel lock in response to the second press operation. By adopting the travel lock, the oral cleaning device 10 may be prevented from being turned on mistakenly when transported or carried.

In one implementation of this embodiment, the controller 610 may be further configured to, for example, control the motor 400 to vibrate in response to the operation signal of the switch 3000 to give feedback to users. The display 2000 is controlled by the controller 610 to display the quantity of electricity, the state of charge, the state of the travel lock or the operating mode. The specific contents and time displayed by the display 2000 may be set, for example, according to actual demands.

In one implementation of this embodiment, the oral cleaning device 10 may further include, for example, a temperature detection module. The temperature detection module is electrically connected to the controller 610 and configured to detect the temperature of the battery 700 and when determining that the temperature is within an abnormal range, control the motor 400 and the airflow generating device 300 not to work and control the battery 700 not to be charged. The temperature detection module may include, for example, an NTC thermistor. A normal temperature range may be, for example, 0-45° C. in the charging process of the battery 700 and −10° C.-60° C. in the discharging process of the battery 700. The temperature is abnormal when exceeding the normal temperature range. By adopting the temperature detection module, damage to the battery 700, the motor 400 or the airflow generating device 300 in the oral cleaning device 10 caused by an abnormal temperature may be avoided, thus improving the safety.

Referring to FIGS. 56-64, a ninth embodiment of the present application provides a brush head 100 for an oral cleaning device for example an electric toothbrush. The brush head 100 includes a shell 110 and bristles 111. The shell 110 is provided with a first airflow channel 101 and a liquid guiding channel 113. The shell 110 has a first side 114 and a second side 115, which are opposite or adjacent to each other. The liquid guiding channel 113 comprises a first liquid guide port 116 and a second liquid guide port 117 that are connected to each other. The first liquid guide port 116 extends through the first side 114, and the second liquid guide port 117 extends through the first side 114 and/or the second side 115. The air inlet of the airflow channel penetrates through the surface of the shell 110, and the air flow hole 112 extends into the liquid guiding channel 113, with the air flow hole 112 facing the first liquid guide port 116. The bristles 111 are arranged on the first side 114.

Accordingly, by providing the first airflow channel 101 and the liquid guiding channel 113 in the shell 110, with the air flow hole 112 extending into the liquid guiding channel 113 and the liquid guiding channel 113 having the first liquid guide port 116 and the second liquid guide port 117 that are connected, the first liquid guide port 116 penetrating through the first side 114, and the second liquid guide port 117 penetrating through the first side 114 and/or the second side 115, the liquid near the brush head 100 can be continuously replenished to the air flow hole 112 through the second liquid guide port 117, allowing the liquid to combine with the air ejected from the air flow hole 112 to continuously form rich bubbles. Then, the bubbles can be sprayed towards the teeth through the first liquid guide port 116 and adhere to the surface of the teeth. The impact generated by the instantaneous collapse and burst of the bubbles can effectively clean the pits and fissures, interproximal surfaces, and other surfaces of the teeth, thereby significantly improving the cleaning effect on the teeth.

By arrangement of the air flow hole 112 extending into the liquid guiding channel 113 and facing the first liquid guide port 116, on the one hand, compared to the arrangement where the air flow hole 112 and the first liquid guide port 116 are placed side by side on the first side 114, the occupied space of the air flow hole 112 and the first liquid guide port 116 on the first side 114 can be effectively reduced, allowing more bristles 111 to be arranged on the first side 114, thereby improving the cleaning effect of the bristles 111 on the teeth and further enhancing the cleaning effect of the oral cleaning device on the teeth. On the other hand, the liquid can flow to the area directly facing the air flow hole 112, making it easier to form more abundant bubbles. That is, not only can the air and the liquid be more easily mixed in the area around the first liquid guide port 116 on the first side 114 to form abundant bubbles, but also the air and the liquid can be more thoroughly mixed in the liquid guiding channel 113 and then sprayed towards the teeth from the first liquid guide port 116, making it easier for bubbles to form and capable of generating more abundant bubbles, so that more bubbles can adhere to the surface of the teeth, resulting in more bubbles collapsing and bursting instantaneously, further improving the cleaning effect on the pits and fissures, interproximal surfaces, and other surfaces of the teeth, and achieving a better cleaning effect on the teeth.

The second liquid guide port 117 penetrating through the first side 114 and/or the second side 115 can be but not limit to the second liquid guide port 117 penetrating through the first side 114, or the second liquid guide port 117 penetrating through the second side 115, or multiple second liquid guide ports 117 being provided, with some second liquid guide ports 117 penetrating through the first side 114 and the other second liquid guide ports 117 penetrating through the second side 115.

In addition, when the second side 115 is adjacent to the first side 114, that is, when the second side 115 is the side adjacent to the first side 114 in the brush head 100, the second liquid guide port 117 can be located on the side of the brush head 100. When the second side 115 is opposite to the first side 114, that is, when the second side 115 is the back side of the brush head 100 opposite to the first side 114, the second liquid guide port 117 can be located on the back side of the brush head 100.

Moreover, the number of the second liquid guide ports 117 can be one or multiple, so that the liquid can flow into the liquid guiding channel 113 more easily through the second liquid guide ports 117, thereby continuously supplementing more liquid to the air outlet of the first airflow channel 101 to form more abundant bubbles, and further improving the cleaning effect on the teeth. When the number of the second liquid guide ports 117 is more than one, the multiple second liquid guide ports 117 can be interconnected to one another.

The number of bristles 111 is multiple, and the multiple bristles 111 are arranged around the first liquid guide port 116, which can effectively prevent the bristles 111 from covering the first liquid guide port 116, so that the bubbles sprayed from the first liquid guide port 116 can smoothly adhere to the teeth in the region that the bristles 111 can clean at present, which is beneficial to improving the cleaning effect.

The air inlet of the air channel penetrates through the surface of the shell 110. For example, the air inlet of the air channel can penetrate through the end face of the shell 110 away from the bristles 111.

Optionally, the bristles 111 is located at the front side of the head portion 110a of the shell 110 of the brush head 100 and the air flow hole 112 is located behind of the first liquid guide port 116 in the thickness direction X of the head portion 110a of the shell 110, thereby the setting of the first liquid guide port 116 does not need to consider the size of the air flow hole 112, so that the first liquid guide port 116 can be set smaller, further reducing the occupied space of the first liquid guide port 116 on the first side 114.

The air flow hole 112 can be located at an area, close to the first liquid guide port 116, in the liquid guiding channel 113, or it can be located in the middle area of the liquid guiding channel 113. This is not limited herein.

In addition, the cross-sectional area of the first liquid guide port 116 is larger than that of the air flow hole 112, and the air flow hole 112 is opposite to the first liquid guide port 116 in the thickness direction of the shell 110.

Thus, the first liquid guide port 116 can provide a relatively sufficient space for the liquid supplemented to the air flow hole 112, and also provide a relatively sufficient space for the mixture of aur and liquid, to form more abundant bubbles, and enable more bubbles to flow smoothly through the first liquid guide port 116 and spray onto the teeth, thereby improving the cleaning effect.

The shape of the first liquid guide port 116 can be any one of circular, elliptical, rectangular, rhombic, etc., which is not limited herein.

The shape of the air flow hole 112 can be any one of circular, elliptical, rectangular, rhombic, etc., which is also not limited herein.

For example, when the first liquid guide port 116 is circular and the air flow hole 112 is circular, the diameter of the first liquid guide port 116 is larger than that of the air flow hole 112.

Optionally, the cross-sectional area of the first liquid guide port 116 is smaller than that of the part of the liquid guiding channel 113 accommodating the air flow hole 112; and/or, the cross-sectional area of the second liquid guide port 117 is larger than that of the part of the liquid guiding channel 113 accommodating the air flow hole 112.

Thus, the cross-sectional area of the flow path is reduced when the bubbles and part of the air not combined with the liquid flow from the air flow hole 112 to the first liquid guide port 116, making the flow of the bubbles and part of the air faster, and the faster part of the air can also drive the flow of the bubbles to be faster, thereby enabling the bubbles to quickly adhere to the surface and crevices of the teeth, and more bubbles can clean the pits and fissures and interproximal surfaces of the teeth through the impact generated by the instantaneous collapse and burst, further improving the cleaning effect of the brush head 100.

The cross-sectional area of the second liquid guide port 117 is larger than that of the part of the liquid guiding channel 113 accommodating the air flow hole 112, such that more liquid can be continuously supplied to the air flow hole 112 through the second liquid guide port 117, thereby continuously forming more bubbles.

That the cross-sectional area of the first liquid guide port 116 is smaller than that of the part of the liquid guiding channel 113 accommodating the air flow hole 112 and the cross-sectional area of the second liquid guide port 117 is larger than that of the part of the liquid guiding channel 113 accommodating the air flow hole 112, comprises that the cross-sectional area of the liquid guiding channel 113 gradually decreases along the direction from the second liquid guide port 117 to the first liquid guide port 116; or the liquid guiding channel 113 includes a first liquid channel section 113a and a second liquid channel section 113b arranged along the direction from the second liquid guide port 117 to the first liquid guide port 116 and connected to each other, the first liquid channel section 113a has one end penetrating the second side 115 to form the second liquid guide port 117, the air flow hole 112 is located in the first liquid channel section 113a, and along the direction from the second liquid guide port 117 to the first liquid guide port 116, the cross-sectional area of the first liquid channel section 113a gradually decreases, and the cross-sectional area of the end of the first liquid channel section 113a close to the second liquid channel section 113b is the same as that of the second liquid channel section 113b.

Optionally, the cross-sectional area of the air flow hole 112 is smaller than that of the air inlet of the air channel. Thus, the air can be ejected from the air flow hole 112 at a higher speed, resulting in a greater pressure difference between the outlet of the air channel and other areas, which enables the surrounding liquid to flow continuously and rapidly through the first liquid guide port 116 and the second liquid guide port 117 towards the air flow hole 112, thereby generating more abundant bubbles.

Optionally, the cross-sectional area of the first airflow channel 101 can gradually decrease along the flow direction of the airflow. Alternatively, the first airflow channel 101 may include a first section 101a and a second section 101b that are interconnected. The first section 101a extends along the length direction of the brush head 100, while the second section 101b is located within the liquid guiding channel 113 and extends towards the first liquid guide port 116. The maximum cross-sectional area of the second section 101b is smaller than the minimum cross-sectional area of the first section 101a. Of course, the cross-sectional area of the airflow hole 112 being smaller than that of the air inlet of the airflow channel can also be achieved in other ways, which are not limited here.

As shown in FIGS. 58 to 64, in some embodiments, the shell 110 includes a base plate 1101 and a bristle mounting part 1103 arranged on the base plate 1101. One side of the bristle mounting part 1103 opposite to the base plate 1101 acts as the first side 114 of the shell 110, and the side of the base plate 1101 opposite to the bristle mounting part 1103 or adjacent to the bristle mounting part 1103 acts as the second side 115 of the shell 110. The first airflow channel 101 is arranged in the base plate 1101, and the liquid guiding channel 113 includes a mixing chamber 34. The mixing chamber 34 is arranged at the side of the bristle mounting part 1103 facing the base plate 1101, and the air flow hole 112 extends into the mixing chamber 34. The mixing chamber 34 extends through the first side 114 to form the first liquid guide port 116, and the bristles 111 are arranged on the bristle mounting part 1103. In this way, the liquid guiding channel 113 and the bristles 111 can be arranged more simply, thereby simplifying the structure of the shell 110, making it easier to implement and reducing costs.

The base plate 1101 may comprise an installation chamber, and the bristle mounting part 1103 may be mounted in the installation chamber, facilitating the assembly of the bristle mounting part 1103 and the base plate 1101. Additionally, the base plate 1101 and the bristle mounting part 1103 may be bonded by adhesive, or they may be snap-fitted or interlocked, or they may be integrally formed by injection molding, and this is not limited herein.

Furthermore, as shown in FIGS. 58 to 64, the liquid guiding channel 113 also includes a liquid inlet chamber 33 communicating with the mixing chamber 34. The liquid inlet chamber 33 is arranged in the base plate 1101, and the liquid inlet chamber 33 extends through the second side 115 to form the second liquid guide port 117. Alternatively, the second liquid guide port 117 may include a first liquid guide sub-port 321 and a second liquid sub-port 322. The liquid inlet chamber 33 includes a first chamber section 331 and a second chamber section 333 that are in communication with each other. The first chamber section 331 is arranged in the base plate 1101 and extends through the second side 115 to form the first liquid guide sub-port 321, and the second chamber section 333 is arranged in the bristle mounting part 1103 and extends through the first side 114 to form the second liquid sub-port 322.

The shell 110 may comprise a body portion 110b (see FIG. 56) and a head portion 110a (see FIG. 56) connected to an end of the body portion 110b. FIGS. 61 and 62 show a head portion 110a illustratively. The bristles 111 and the air outlet hole 112 of the first airflow channel are arranged at the head portion 110a. The liquid outlet port 116 of the liquid guiding channel 113 is located at the side of the head portion 110a on which the bristles 111 are arranged. The air outlet hole 112 of the first airflow channel 101 and the liquid outlet port 116 of the liquid guiding channel 113 are spaced apart in a thickness direction X of the head portion 110a which is perpendicular to a lengthwise direction Y (see FIG. 56) of the body portion 110b. The bristles 111 extend from the head portion 110a in the thickness direction X of the head portion 110a. The head portion 110a may comprise a first part 110a1 and a second part 110a2. The bristles 111 and the liquid inlet port 321 of the liquid guiding channel 113 are arranged at the first part 110a1; the liquid outlet port 116 of the liquid guiding channel 113 is defined in the second part 110a2; and the first part 110a1 surrounds the second part 110a2 with a passage formed therebetween. The second chamber section 333 may also be named as a passage 333 formed between the first part 110a1 and the second part 110a2 of the head portion 110a. The passage 333 is in fluid communication with the liquid guiding channel 113. Specifically, the first part 110a1 defines a round opening and the second part 110a2 is received in the round opening. The second part 110a2 has a cylinder shape and the passage 333 is formed between the inner circumferential surface of the round opening of the first part 110a1 and the outer circumferential surface of the second part 110a2. The passage 333 can be one annular-shaped passage 333 around the second part 110a2 or multiple passages 333 arranged at an interval around the second part 110a2.

The passage 333 surrounds the liquid outlet port 116 of the liquid guiding channel. The second liquid sub-port 322 acts as the inlet port of the passage 333. The inlet port 322 of the passage 333 is located at the side of the head portion 110a on which the liquid outlet port 116 of the liquid guiding channel is arranged.

The liquid inlet port 321 of the liquid guiding channel 113 is arranged at a side of the first part 110a1 opposite to the bristles 111. The side of the first part 110a1 opposite to the bristles 111 acts as the second side 115 of the head portion 110a of the shell 110.

The liquid inlet port 321 of the liquid guiding channel 113 arranged at the second side 115 of the head portion 110a is flared in a direction away from the liquid outlet port 116 of the liquid guiding channel 113. That is, the cross-sectional area of the liquid inlet port 321 increases in the direction from the first side 114 toward the second side 115 of the head portion 110a the shell 110. This direction is parallel to the first direction X.

Accordingly, the second liquid guide port 117 can be set on a surface different from the first liquid guide port 116, or the second liquid guide port 117 can be set on the same surface as the first liquid guide port 116, so that the number of the second liquid guide ports 117 can be one or multiple. When the number of the second liquid guide ports 117 is multiple, the setting positions of the second liquid guide ports 117 can have more options, which not only enables sufficient liquid to continuously flow to the air flow hole 112, but also greatly facilitates the setting of the second liquid guide ports 117, effectively reducing the difficulty of setting the brush head 100.

The liquid inlet chamber 33 extends through the second side 115 to form the second liquid guide port 117. The second side 115 can be the side of the base plate 1101 opposite to the bristle mounting part 1103 and the second liquid guide port 117 is thus opposite to the first side 114. Alternatively, the second side 115 can also be the side of the base plate 1101 adjacent to the bristle mounting part 1103 and the second liquid guide port 117 is thus adjacent to the first side 114.

Similarly, when the first chamber section 331 is set in the base plate 1101 and extends through the second side 115 to form the first liquid sub-port 321. The first liquid sub-port 321 can be opposite to the first side 114 or adjacent to the first side 114. This is not limited thereto.

Optionally, along the direction approaching the first liquid guide port 116, the cross-sectional area of the liquid inlet chamber 33 gradually decreases, which enables the liquid flowing in through the second liquid guide port 117 to flow smoothly into the mixing chamber 34, reducing the resistance of the liquid flowing in the liquid guiding channel 113, and also allows the size of the second liquid guide port 117 to be larger, so that more liquid at the second side 115 can flow into the liquid guiding channel 113 through the second liquid guide port 117, thereby enabling more liquid to be replenished to the air flow hole 112 and continuously generating abundant bubbles.

The chamber wall of the liquid inlet chamber 33 and the chamber wall of the mixing chamber 34 can be smoothly connected to form a smooth transition therebetween, so that the liquid can flow smoothly towards the outlet of the first airflow channel 101. The cavity wall of the liquid inlet chamber 33 and the cavity wall of the mixing chamber 34 can be smoothly connected through an arc surface, or the shape of the part of the liquid inlet chamber 33 close to the mixing chamber 34 can be the same as the shape of the part of the mixing chamber 34 close to the liquid inlet chamber 33, so that the chamber wall of the liquid inlet chamber 33 and the chamber wall of the mixing chamber 34 can be smoothly connected together. This is not limited thereto.

In addition, the cross-sectional shape of the liquid inlet chamber 33 can be any of circular, elliptical, rectangular, etc., and this is not limited. The cross-sectional shape of the mixing chamber 34 can be any of circular, elliptical, rectangular, etc., and this is also not limited.

Optionally, as shown in FIGS. 54 and 60, the first airflow channel 101 includes a straight hole section 22 and a curved pipe section 25. The straight hole section 22 is arranged in the base plate 1101 and extends in the length direction Y of the base plate 1101 which is perpendicular to the extending direction of the bristles 111. The air inlet hole of the airflow channel 101 extends through the end face of the brush head 100 and is in fluid communication with the inlet of the straight hole section 22. The outlet of the straight hole section 22 extends through the chamber wall of the liquid inlet chamber 33. A curved pipe extends from the chamber wall of the liquid inlet chamber 33 into the interior space of the liquid inlet chamber 33, and the curved pipe section 25 extends through the curved pipe. One end of the curved pipe section 25 is connected to the outlet of the straight hole section 22, and the other end of the curved pipe section 25 forms the airflow hole 112. The airflow hole 112 extends into the mixing chamber 34, and faces and is aligned with the first liquid guide port 116. A liquid passage gap is formed between the curved pipe and the inner wall of the mixing chamber 34, and the liquid passage gap is connected to the liquid inlet chamber 33.

Thus, the first airflow channel 101 has a relatively simple structure. Moreover, the airflow hole 112 extends into the mixing chamber 34 and face the first liquid guide port 116, which enables the formed bubbles to be directly ejected through the first liquid guide port 116, allowing the bubbles to quickly adhere to the surface of the teeth, so that more bubbles can clean the pits and fissures and adjacent surfaces of the teeth.

Additionally, by forming a liquid passage gap between the curved pipe and the inner wall of the mixing chamber 34, and the liquid passage gap being in communication with the liquid inlet chamber 33, the liquid around the airflow hole 112 can be more evenly distributed, facilitating forming more abundant bubbles at the airflow hole 112.

It can be understood that the air inlet of the airflow channel can be the air inlet of the straight hole section 22. The airflow hole 112 can be the air outlet of the curved pipe section 25.

Optionally, as shown in FIG. 60, the mixing chamber 34 includes a first mixing chamber section 341 and a second mixing chamber section 342 that are connected to each other. The first mixing chamber section 341 is close to the base plate 1101, and the second mixing chamber section 342 is close to the bristles 111. The airflow hole 112 is located in the first mixing chamber section 341. The first mixing chamber section 341 may be named as a recessed cavity which is in communication with the liquid outlet port 116 of the liquid guiding channel, and the recessed cavity faces the air outlet hole of the first airflow channel. Preferably, the first mixing chamber section 341, the second mixing chamber section 342, the liquid outlet port 116 and the air outlet hole 112 of the first airflow channel are coaxial. Along the direction from the airflow hole 112 towards the first liquid guide port 116 (as shown by the direction X in FIG. 60), the cross-sectional area of the first mixing chamber section 341 gradually decreases, and the cross-sectional area of the second mixing chamber section 342 is the same as the minimum cross-sectional area of the first mixing chamber section 341.

As a result, the space at the airflow hole 112 is larger, providing a larger space to allow more bubbles to form around the airflow hole 112, making the mixing of liquid and air easier and more thorough, thereby generating more abundant bubbles. Moreover, during the process of the bubbles flowing from the first mixing chamber section 341 to the second mixing chamber section 342, the speed of the bubbles increases gradually, allowing the bubbles to adhere to the surface of the teeth more quickly, and enabling more bubbles to clean the pits and fissures and adjacent surfaces of the teeth through the impact generated by the instantaneous collapse and burst, further improving the cleaning effect.

The second mixing chamber section 342 may have a cylindrical structure. Additionally, the second mixing chamber section 342 may have a uniform cross-sectional area. Alternatively, the cross-sectional area of the second mixing chamber section 342 can gradually decrease along the direction from the second side 115 toward the first side 114. This is not limited here.

As shown in FIGS. 59 and 60, the curved pipe section 25 includes a first curved pipe section 251 and a second curved pipe section 252 that are connected to each other. The end of the first curved pipe section 251 far from the second curved pipe section 252 is connected to the air outlet of the straight hole section 22. The first curved pipe section 251 extends along the extension direction of the straight hole section 22, and the second curved pipe section 252 extends from the first curved pipe section 251 towards the first liquid guide port 116. The minimum cross-sectional area of the first curved pipe section 251 perpendicular to the flowing direction of the air is greater than the maximum cross-sectional area of the second curved pipe section 252. Optionally, the shell 110 comprises a protrusion 1104 located in the liquid guiding channel 113. The first curved pipe section 251 and a second curved pipe section 252 are formed in the protrusion 1104. The second curved pipe section 252 acts as the air outlet hole of the first airflow channel 101. That is, the air outlet hole of the first airflow channel 101 is defined in the protrusion 1104 and faces the liquid outlet port 116 of the liquid guiding channel 113.

As a result, the flow rate of the air flowing from the first curved pipe section 251 to the second curved pipe section 252 can increase, enabling the air to be ejected from the airflow hole 112 at a faster speed, thereby creating a stronger negative pressure zone at the airflow hole 112, allowing the surrounding liquid to flow towards the airflow hole 112 more quickly and continuously, and forming more abundant bubbles.

It should be noted that the first curved pipe section 251 extending along the extension direction of the straight hole section 22 means that the first curved pipe section 251 extends approximately along the extension direction of the straight hole section 22, and it is not necessarily exactly along the extension direction of the straight hole section 22.

The angle between the first curved pipe section 251 and the second curved pipe section 252 can be 90°. Of course, the angle between the first curved pipe section 251 and the second curved pipe section 252 can also be 100°, 60°, etc., and this is not limited here.

Additionally, the inner wall of the hole in the first curved pipe section 251 and the inner wall of the hole in the straight hole section 22 can be smoothly connected to form a smooth transition, so that the air can flow from the straight hole section 22 to the first curved pipe section 251 more smoothly.

Optionally, as shown in FIGS. 59 and 60, the cross-sectional area of the second curved pipe section 252 gradually increases along the airflow direction. As shown in FIG. 62, the head portion 110a has a thickness which gradually decreases from an end, close to the body portion, of the head portion 110a to another end, away from the body portion, of the head portion 110a.

Thus, the air can gradually diffuse during its flow to the outlet of the second curved pipe section 252, so that the air flowing out of the air flow hole 112 can spread to a larger area, and the air can simultaneously combine with more liquid to form bubbles, thereby generating more abundant bubbles, and more bubbles can clean the pits and fissures and interdental surfaces of teeth through the impact generated by the instantaneous collapse and burst, further improving the cleaning effect.

Wherein, the cross-sectional area of the part of the second curved pipe section 252 close to the first curved pipe section 251 can be the same. For example, the part of the second curved pipe section 252 close to the first curved pipe section 251 may have a cylindrical structure, a prismatic structure, etc. Alternatively, the cross-sectional area of the part of the second curved pipe section 252 close to the first curved pipe section 251 can also gradually increase along the direction toward the first liquid guide port 116, that is, the part of the second curved pipe section 252 close to the first curved pipe section 251 can be a conical structure, and this is not limited herein.

As shown in FIG. 61, the head portion of the shell 110 comprises a main body part 1111 such as a rigid main body part 1111 and a flexible part 1112 such a rubber part sleeved on the main body part 1111, and the liquid guiding channel 113 extends through the main body part 1111 and the flexible part 1112. One side of the flexible part 1112 defines an opening to expose one side of the main body part 1111 such that the bristles 111 can be fixed to the main body part 1111. The other side of the flexible part 1112 away from the bristles 111 covers the other side of the main body part 1111 away from the bristles 111. The liquid guiding channel 113 extends through the two opposite sides of the main body part 1111 and the rubber part 111 in the thickness direction X of the head portion 110a of the shell 110.

As shown in FIG. 64, the bristles 111 at both ends of the head portion 110a have a height higher than that of the bristles 111 in the middle of the head portion 110, which facilitating improving the cleaning effect. The height of the bristles 111 refers to the length of the bristles 111 extending beyond the first side 114 of the shell 110 in the thickness direction X of the head portion 110a of the shell 110.

As shown in FIG. 65, in some embodiments, a trumpet-shaped liquid guiding surface is provided around the second liquid guide port 117 on the second side 115, and the liquid guiding surface is configured to guide the liquid to flow towards the second liquid guide port 117. Thus, the liquid on the second side 115 can flow towards the second liquid guide port 117 more smoothly, and then flow into the liquid guiding channel 113 through the second liquid guide port 117, so that the liquid can be sufficiently replenished to the air flow hole 112 to form more abundant bubbles.

The periphery edge of the second liquid guide port 117 can be smoothly connected with the liquid guiding surface, effectively reducing the resistance of the liquid flowing from the second side 115 to the liquid guiding channel 113.

Additionally, the periphery edge of the first liquid guide port 116 is smoothly connected with the first side 114, effectively reducing the resistance of the liquid flowing from the first side 114 to the liquid guiding channel 113.

Referring to FIGS. 66 to 68, the present application further provides an oral cleaning device 10 applying the toothbrush head 100. The oral cleaning device 10 includes a handle 200, a motor 400, a pump 40, and the brush head 100 described above. The motor 400 and the pump 40 are both arranged inside the handle 200. The drive shaft 410 of the motor 400 defines a second airflow channel 201 extending along a length direction thereof. The outlet of the pump 40 is connected to the second airflow channel 201. The air inlet hole 1011 (labelled in FIG. 65) of the first airflow channel 101 extends through the end of the brush head 100 away from the bristles 111, and the handle 200 is connected to the brush head 100 and seals the inlet of the airflow channel 101. The drive shaft 410 of the motor 400 passes through the inlet of the airflow channel and extends into the first airflow channel 101, and the second airflow channel 201 is in fluid communication with the first airflow channel 101.

Thus, by the drive shaft 410 of the motor 400 passing through the air inlet of the airflow channel and extending into the first airflow channel 101, that is, the drive shaft 410 of the motor 400 is connected to the brush head 100. When the motor 400 works, the drive shaft 410 of the motor 400 can drive the brush head 100 to vibrate or rotate to clean the teeth. The second airflow channel 201 is defined in the drive shaft 410 of the motor 400 and extends along the length direction of the drive shaft 410. The outlet of the air pump 40 is connected to the second airflow channel 201 which is connected to the first airflow channel 101. When the air pump 40 works, it can supply air to the first airflow channel 101 inside the brush head 100, so that the air can be sprayed out through the air flow holes 112 and combined with the liquid to form bubbles. The bubbles are sprayed onto the tooth surface and the tooth gap through the first liquid guide port 116 to clean the tooth pits and fissures and the interdental surfaces by the impact generated when the bubbles collapse and burst instantly. Moreover, when the motor 400 drives the brush head 100 to vibrate or rotate, it can also make the mixture of toothpaste and liquid produce fine bubbles, which cooperate with the bubbles formed by the air sprayed out from the air flow holes 112 and liquid, so that the brush head 100 can produce more abundant bubbles to clean the tooth surfaces, pits and fissures, and interdental surfaces, further improving the cleaning effect of the oral cleaning device 10.

Furthermore, the brush head 100 in the oral cleaning device 10 is any of the brush heads 100 described in the above embodiments. Therefore, the brush head 100 in the oral cleaning device 10 can produce the same or similar beneficial effects as the brush heads 100 described in the above embodiments, and will not be elaborated here.

The motor 400 can be a vibration motor 400 or a rotation motor 400, and there is no limitation here.

In addition, the connection between the handle 200 and the brush head 100 can be a detachable connection, which is convenient for users to replace the brush head 100 according to their needs, improving the user's experience. Alternatively, the connection between the handle 200 and the brush head 100 can also be a fixed connection, which can make the connection between the handle 200 and the brush head 100 more stable.

Optionally, as shown in FIG. 67, a sensing component 50 is attached to the outer wall of the drive shaft 410 of the motor 400. The sensing component 50 is configured to detect the pressure applied by the brush head 100 to the drive shaft 410 of the motor 400.

Thus, the pressure applied by the teeth to the brush head 100 during brushing can be determined by the pressure, applied by the brush head 100 to the drive shaft 410 of the motor 400, detected by the sensing component 50, so that the toothbrush can execute corresponding programs according to the detected pressure, such as not starting when the brush head 100 is not subjected to pressure, reminding the user to stop when the pressure applied on the brush head 100 is large, and starting the brushing program when the pressure applied on the brush head 100 is light or proper, effectively improving the user's experience.

The sensing component 50 can be any one of strain gauge sensing element, ceramic sensing element, piezoelectric quartz crystal sensing element, etc., and no limitation is imposed here.

The number of the sensing component 50 can be one, two or more, and there is no limitation here.

In addition, the oral cleaning device 10 may also include a controller which is electrically connected to the sensing component 50, the motor 400 and the air pump 40 respectively. The controller can control the start and stop of the motor 400 and the air pump 40 based on the pressure detected by the sensing component 50.

The present application further provides a brush head according to another embodiment. Referring to FIGS. 69 to 71, the brush head of this embodiment is similar to the brush head as shown in FIGS. 61 to 62 except the followings: in this embodiment, the first part 110a1 of the shell 110 of the brush head 100 has a mounting chamber 181 concavely formed on the side where the bristles 111 are located. The first part 110a1 and the second part 110a2 are separately formed. The second part 110a2 is mounted in the mounting chamber 181. Due to the complex structure inside the liquid guiding channel 113, setting the first part 110a1 and the second part 110a2 as separate parts facilitates the formation of the internal structure of the liquid guiding channel 113 and the formation of the second chamber section 333. The mounting chamber 181 has an elliptical shape defining a length direction and a width direction perpendicular to the length direction. The size of the mounting chamber 181 in the length direction is greater than the size of the mounting chamber 181 in the width direction. The length direction of the mounting chamber 181 is along the length direction Y of the brush head 100. The second part 110a2, which is mounted in the mounting chamber 181, has an elliptical shape of which the length direction is perpendicular to the length direction Y of the brush head 100. That is, the length direction of the second part 110a2 is consistent with the width direction of the mounting chamber 181. Since the width direction size of the second part 110a2 is smaller than the length direction size of the mounting chamber 181, two second chamber sections 333 are respectively formed on opposite sides of the second part 110a2 in the width direction, that is, two second chamber sections 333 are respectively formed between the outer side walls of the second part 110a2 in the width direction of the second part 110a2 and the inner side walls of the mounting chamber 181 in the length direction of the mounting chamber 181.

To facilitate the assembly of the second part 110a2, the second part 110a2 has a snap-fit portion 193 convexly formed on its side. The second part 110a2 is snap-fitted with the first part 110a1 through the snap-fit portion 193. Specifically, the second part 110a2 has a snap-fit portion 193 formed on each of its opposite side walls in the length direction thereof. Each of the opposite side walls of the mounting chamber 181 defines a locking notch 1811 corresponding to the snap-fit portion. The snap-fit portions 193 and the corresponding locking notches 1811 are snap-fitted together. During assembly, the second part 110a2 can be pressed into the mounting chamber 181 of the first part 110a1, which is convenient. Of course, the second part 110a2 can also be fixed in the mounting chamber 181 by means of adhesion or other methods.

In addition, it is understandable that the above embodiments are merely for an illustrative description of the application, and the technical solutions in the above embodiments may be combined and integrated arbitrarily without causing feature conflicts and structural contradictions and departing from the purposes of the application.

It should be understood that the system, device and method disclosed in several embodiments of the application may be implemented in other ways. For example, the device embodiments described above are merely illustrative. For example, the units are divided according to their logic functions, and in actual implementation, the units may be divided in other ways. For example, multiple units or assemblies may be combined or integrated in another system, or some features may be ignored or not executed. In addition, coupling, direct coupling or communication connection displayed or discussed above may be indirect coupling or communication connection between devices or units via some interfaces, or electrical, mechanical or other connections.

Units described as discrete components may be or may be not physically separated. Components displayed as units may be or may be not physical units, that is, they may be located in the same network unit or distributed in multiple network units. All or part of the units may be selected to fulfill the purposes of the embodiments of the application as actually needed.

Finally, it should be noted that the above embodiments are merely used for explaining the technical solutions of the application and are not intended to limit the application. Although the application has been described in detail with reference to the above embodiments, those ordinarily skilled in the art should understand that modifications may be made to the technical solutions in the above embodiments or equivalent substitutions may be made to part of the technical features in the above embodiment without departing from the spirit and scope of the technical solutions in the embodiments of the application.

What is claimed is:

1. A brush head, comprising:
a shell comprising a first airflow channel and a liquid guiding channel; and
bristles arranged at a side of the shell;
wherein the first airflow channel comprises an air outlet hole facing the side of the shell on which the bristles are arranged; and
the liquid guiding channel comprises a liquid outlet port located at the side of the shell on which the bristles are arranged.

2. The brush head according to claim 1, wherein the shell comprises a body portion and a head portion connected to an end of the body portion;
the bristles and the air outlet hole of the first airflow channel are arranged at the head portion; and
the liquid guiding channel extends through the head portion, the liquid outlet port of the liquid guiding channel is located at a side of the head portion on which the bristles are arranged, and the liquid guiding channel further comprises a liquid inlet port defined at another side of the head portion opposite to or adjacent to the side of the head portion on which the bristles are arranged.

3. The brush head according to claim 2, wherein the head portion has a thickness which gradually decreases from an end, close to the body portion, of the head portion to another end, away from the body portion, of the head portion.

4. The brush head according to claim 1, wherein the shell comprises a protrusion located in the liquid guiding channel; and
the air outlet hole of the first airflow channel is defined in the protrusion and faces the liquid outlet port of the liquid guiding channel.

5. The brush head according to claim 4, wherein the shell comprises a head portion;
the bristles and the air outlet hole of the first airflow channel are arranged at the head portion;
the liquid outlet port of the liquid guiding channel is located at a side of the head portion from which the bristles extend in an extending direction; and
the air outlet hole of the first airflow channel and the liquid outlet port of the liquid guiding channel are spaced apart in a thickness direction of the head portion which is parallel to the extending direction of the bristles.

6. The brush head according to claim 5, wherein the head portion comprises a first part and a second part;
the bristles and the liquid inlet port of the liquid guiding channel are arranged at the first part;
the liquid outlet port of the liquid guiding channel is defined in the second part; and
the first part surrounds the second part with a passage being formed therebetween, the passage being in fluid communication with the liquid guiding channel.

7. The brush head according to claim 6, wherein multiple said passages are formed between the first part and the second part and arranged around the liquid outlet port of the liquid guiding channel; and
each of the multiple said passages comprises an inlet port which is located at the side of the head portion on which the liquid outlet port of the liquid guiding channel is arranged.

8. The brush head according to claim 6, wherein the liquid outlet port of the liquid guiding channel is arranged at a side of the second part away from the air outlet hole of the first airflow channel; and
the second part comprises a recessed cavity formed at another side thereof adjacent to the air outlet hole of the first airflow channel, the recessed cavity is in communication with the liquid outlet port of the liquid guiding channel, and the recessed cavity faces the air outlet hole of the first airflow channel.

9. The brush head according to claim 8, wherein the recessed cavity is flared in a thickness direction of the head portion away from the bristles.

10. The brush head according to claim 9, wherein the liquid inlet port of the liquid guiding channel is arranged at a side of the first part opposite to the bristles, and the liquid inlet port of the liquid guiding channel is flared in a direction away from the liquid outlet port of the liquid guiding channel.

11. The brush head according to claim 1, wherein the shell comprises a body portion and a head portion connected to an end of the body portion;
the bristles and the air outlet hole of the first airflow channel are arranged at the head portion;
the first airflow channel extends in a lengthwise direction of the body portion; and
the first airflow channel comprises an air inlet hole located at an end of the body portion away from the head portion.

12. The brush head according to claim 11, wherein the air outlet hole of the first airflow channel has a cross-sectional area less than that of the air inlet hole of the first airflow channel.

13. The brush head according to claim 12, wherein the air outlet hole of the first airflow channel has a cross-sectional area less than that of the liquid outlet port of the liquid guiding channel.

14. The brush head according to claim 11, wherein the bristles are arranged around the air outlet hole of the first airflow channel and the liquid outlet port of the liquid guiding channel.

15. The brush head according to claim 14, wherein the head portion of the shell comprises a main body part and a flexible part sleeved on the main body part, and the liquid guiding channel extends through the main body part and the flexible part.

16. An electric toothbrush, comprising a housing, an air pump and a brush head as claimed in claim 1, wherein the air pump is arranged in the housing, the brush head is connected to an end of the housing, and the air pump comprises an air outlet hole in communication with the air inlet hole of the first airflow channel.

17. The electric toothbrush according to claim 16, further comprising a vibration motor which comprises a driving shaft connected to the shell, wherein the driving shaft defines a second airflow channel, and opposite two ends of the second airflow channel are connected to the air outlet hole of the air pump and the air inlet hole of the first airflow channel respectively.

18. The electric toothbrush according to claim 17, wherein a sealing member is sleeved around the driving shaft to sealingly connect the air inlet hole of the first airflow channel and an air outlet hole of the second airflow channel.

19. The electric toothbrush according to claim 18, wherein the bristles are arranged at an end of the shell away from the housing;
a locking member is arranged at another end of the shell adjacent to the housing, the locking member defines a mounting hole in communication with the first airflow channel, and the driving shaft of the vibration motor is mounted in the mounting hole;
a limiting portion is provided at said another end of the shell adjacent to the housing for limiting stroke of the driving shaft entering into the mounting hole; and
the sealing member is sandwiched between the limiting portion and the locking member.

20. The electric toothbrush according to claim 18, wherein a waterproof air inlet cap assembly is provided at an end of the housing away from the brush head;
the waterproof air inlet cap assembly comprises an air inlet cap defining through holes, a cover, and a waterproof and air-permeable member;
the waterproof and air-permeable member is sandwiched between the air inlet cap and the cover; and
a periphery of the waterproof air inlet cap assembly is sealingly connected to the housing.
